(19) United States
(12) Patent Application Publication
(10) Pub. No.: US 2005/0165922 A1
(43) Pub. Date: Jul. 28, 2005

(54) Device management apparatus and method

(75) Inventor: Manami Hatano, Kanagawa (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 10/854,279

(22) Filed: May 27, 2004

(30) Foreign Application Priority Data
May 30, 2003 (JP) 2003-154896

(51) Int. Cl. G06F 15/173

(52) U.S. Cl. 709/223

(57) ABSTRACT

This invention provides a network device management apparatus and method, which manage one or a plurality of devices connected to a network. A layout data storage unit stores layout map data which indicates locations, identifiers of devices set at different locations, and status of the devices. A device data storage unit stores device data. Icons indicating locations and type of devices are displayed on a display based on the layout map data. When a instruction of generating layout map data is issued, device data corresponding to the locations of the layout map data are extracted from the device data, and the layout map data is updated in correspondence with editing of device data and stored in the layout map data storage unit.

### FIELD OF THE INVENTION

The present invention relates to a device management apparatus and method for managing one or a plurality of devices.

### BACKGROUND OF THE INVENTION

In order to efficiently manage a plurality of devices connected to a network, a management apparatus which provides a mechanism for setting and storing respective device names, locations, and the like, and manages a plurality of devices connected to the network using such information is known. Also, a management apparatus which has a function of displaying a two-dimensional (2D) layout map on a display, and displaying the layout of devices in an office on the layout map together with their shapes so as to facilitate device management is available (see Japanese Patent Laid-Open No. 2002-149515).

However, with such device management using the 2D layout map, an administrator must select devices to be laid out with reference to information of respective devices so as to lay out devices in a given room every time he or she creates the 2D layout map in the room. When the location of each device has been changed, the layout maps before and after the change must be individually corrected, resulting in considerable labor of the administrator.

### SUMMARY OF THE INVENTION

The present invention has been made in consideration of the aforementioned prior arts, and has as its feature to provide a device management apparatus and method, which can efficiently register or delete a device on or from a layout map by managing device information and the layout map in correspondence with each other.

According to one aspect of the present invention, a device management apparatus and method which classify a plurality of devices into groups, and allow to clearly determine a device which belongs to the group of interest and other devices can be provided.

According to another aspect of the present invention, there is provided with a device management apparatus and method which allow easy determination of each device status.

An aspect of the present invention, there is provided with a device management method comprising: a display step of displaying information indicating a device on a map on the basis of map data including information indicating a name of the map, identification information of the device set in correspondence with the map, and information indicating a position of the device on the map; and a registration step of registering the identification information of the device in the map data in accordance with correspondence between a location set for the device, and the information indicating the position of the device on the map.

Another aspect of the present invention, there is provided with a device management apparatus comprising: a device management apparatus, comprising: display means for displaying information indicating a device on a map on the basis of map data including information indicating a name of the map, identification information of the device set in correspondence with the map and information indicating a position of the device on the map; and registration means for registering the identification information of the device in the map data in accordance with the correspondence between a location set for the device, and the information indicating a position of the device on the map.

Other features and advantages of the present invention will be apparent from the following description taken in conjunction with the accompanying drawings, in which like reference characters designate the same or similar parts throughout the figures thereof.

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 is a block diagram showing the arrangement of an information processing apparatus (management apparatus) according to an embodiment of the present invention;

FIG. 2 depicts an example of an edit window of 2D layout map data according to the embodiment of the present invention;

FIG. 3 is a flowchart showing the processing sequence in the information processing apparatus according to a first embodiment of the present invention;

FIG. 4 depicts a diagram for explaining the data configuration of 2D layout map data according to the embodiment of the present invention;

FIG. 5 depicts a view for explaining the layer structure of 2D layout map data according to the embodiment of the present invention;

FIG. 6 depicts a diagram for explaining the data structure in a device list according to the embodiment of the present invention;

FIG. 7 shows an example of a window used to instruct generation of 2D layout map data according to a second embodiment of the present invention;

FIG. 8 is a flowchart showing the processing sequence in the information processing apparatus according to the second embodiment of the present invention;

FIG. 9 is a flowchart showing the processing sequence in the information processing apparatus according to a third embodiment of the present invention;

FIG. 10 is a flowchart showing the processing sequence in the information processing apparatus according to a fourth embodiment of the present invention;

FIGS. 11A and 11B are flowcharts showing the processing sequence in the information processing apparatus according to a fifth embodiment of the present invention;

FIG. 12 shows an example of a window used to manage 2D layout map data according to a sixth embodiment of the present invention;

FIGS. 13A and 13B are flowcharts showing the processing sequence in the information processing apparatus according to the sixth embodiment of the present invention;

FIGS. 14A and 14B are flowcharts showing the processing sequence in the information processing apparatus according to the sixth embodiment of the present invention;

FIG. 15 depicts a display example of an edit/creation window of a 2D layout map according to seventh and eighth embodiments of the present invention;

FIG. 16 is a flowchart showing the processing sequence in the information processing apparatus according to the seventh embodiment of the present invention;

FIG. 17 depicts an example of generation of new location data according to the seventh embodiment;

FIG. 18 is a flowchart showing the processing sequence in the information processing apparatus according to the eighth embodiment of the present invention;

FIGS. 19A to 19C are flowcharts showing the processing sequence in the information processing apparatus according to a ninth embodiment of the present invention;

FIGS. 20A and 20B are flowcharts showing the processing sequence in the information processing apparatus according to the ninth embodiment of the present invention;

FIG. 21 depicts a diagram showing the data configuration of device list data according to the ninth and 10th embodiments of the present invention;

FIG. 22 shows a display example of a 2D layout map window according to the ninth to 11th embodiments of the present invention;

FIG. 23 depicts a view showing a display example of icon images used to explain the display patterns of “replied device” and “non-replied device” according to the ninth to 11th embodiments of the present invention;

FIG. 24 depicts a view showing a display example of icon images used to explain the display patterns of “replied device” and “non-replied device” according to the 19th embodiment of the present invention;

FIG. 25 depicts a diagram for explaining the software configuration according to the 11th embodiment of the present invention;

FIG. 26 depicts a diagram showing the data configuration of device list data according to the 11th embodiment of the present invention;

FIGS. 27A to 27D are flowcharts for explaining a process by a device data acquisition process according to the 11th embodiment of the present invention;

FIG. 28 is a flowchart for explaining a process by a 2D layout map display process according to the 11th embodiment of the present invention;

FIGS. 29A to 29D are flowcharts showing the processing sequence in the information processing apparatus according to the 12th embodiment of the present invention;

FIG. 30 depicts a diagram for explaining a data example of the contents of device group data which describes the contents of a device group, according to the 12th embodiment of the present invention;

FIG. 31 shows an example of the display patterns of an icon used to display a device which belongs to a device group, and an icon used to display a device which does not belong to the device group, according to the 12th embodiment of the present invention;

FIGS. 32A to 32D are flowcharts showing the processing sequence in the information processing apparatus according to the 13th embodiment of the present invention;

FIGS. 33A and 33B are flowcharts showing the processing sequence in the information processing apparatus according to the 14th embodiment of the present invention; and

FIG. 34 is a flowchart showing the processing sequence of a 2D layout map display process according to the 14th embodiment of the present invention.

### DETAILED DESCRIPTION OF THE PREFERRED EMBODIMENTS

Preferred embodiments of the present invention will be described in detail hereinafter with reference to the accompanying drawings. Note that an apparatus which manages image output devices (printer, hybrid copying machine having print and FAX functions, and the like) connected to a network will be exemplified below. However, the present invention can be practiced as an apparatus which manages not only such image output devices but also manages devices via the network, which are connected to a general network. Also, the present invention can be used to manage a data storage device or the like which is distributed on the network upon use.

### First Embodiment

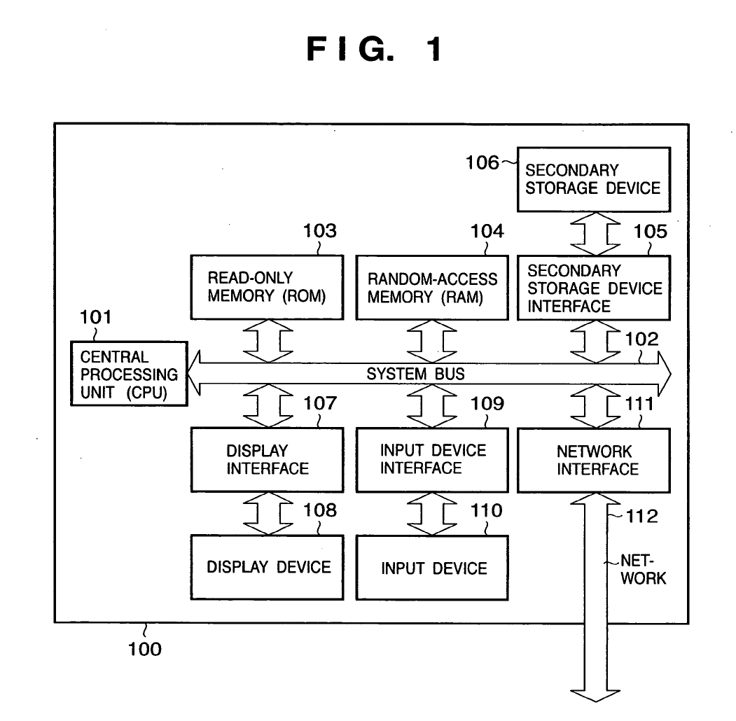

FIG. 1 is a block diagram showing an overview of the functions of an information processing apparatus (management apparatus: computer apparatus) 100 according to an embodiment of the present invention.

Referring to FIG. 1, reference numeral 101 denotes a central processing unit (CPU) of the apparatus 100. Reference numeral 102 denotes a system bus which connects the CPU 101 to respective units to be described below, and includes an address bus, data bus, and control bus. Reference numeral 103 denotes a read-only memory (ROM), which stores programs to be executed by the CPU 101, data, and the like. Reference numeral 104 denotes a random-access memory (RAM), which temporarily stores required data during the control operation of the CPU 101 for use later. Reference numeral 105 denotes a secondary storage device interface, which reads/writes information from/to a secondary storage device (hard disk, MO, or the like) 106. Reference numeral 107 denotes a display interface which controls display on a display device 108. The display device 108 is a display unit such as a liquid crystal display, plasma display, CRT display, or the like. Reference numeral 109 denotes an input device interface which controls interface between the CPU 101 and an input device 110, which is used by the user to input instructions and data to the apparatus 100. The input device 110 includes a keyboard, a pointing device such as a mouse or the like, and the like. Reference numeral 111 denotes a network interface which is used when this apparatus 100 transmits/receives data via a network 112. The network 112 includes a LAN, ISDN, public network, Internet, or the like.

Note that programs that describe the operation sequence for making the apparatus 100 execute processes to be described later are stored in the ROM 103, or installed in the secondary storage device 106, or supplied from the network 112, and upon execution, the programs stored in the secondary storage device 106 are loaded in the RAM 104 and executed by the CPU 101. When programs to be used by the apparatus 100 are externally supplied, a plurality of secondary storage devices 106 may be connected, and required programs, data, and the like may be loaded into the RAM 104, upon implementing the program.

Also, in the following description, the subject of execution of processes in the apparatus 100 is the CPU 101 unless otherwise specified. As the program, a single program may run, or functions to be described below may be implemented as a result when a plurality of programs run in cooperation.

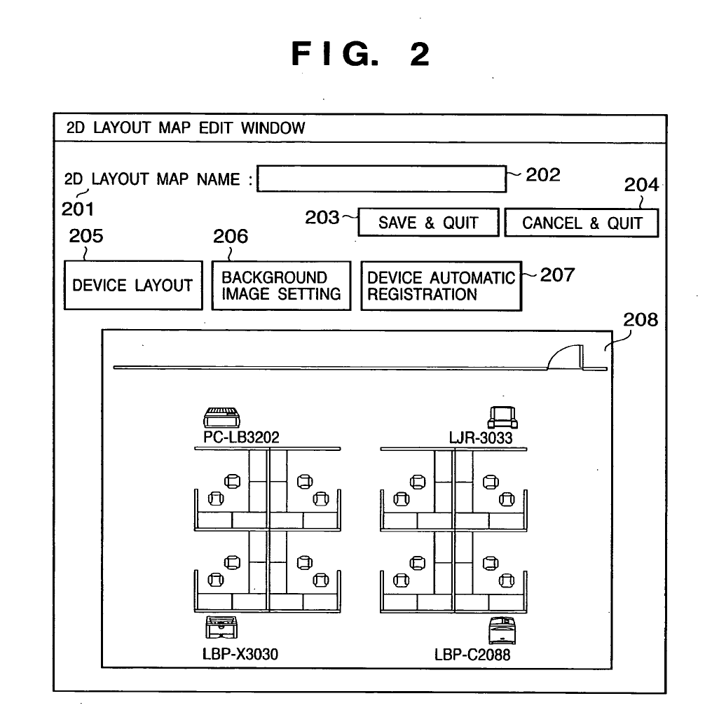

FIG. 2 shows an example of a 2D layout map edit window displayed on the display device 108 in the information processing apparatus 100 according to the embodiment.

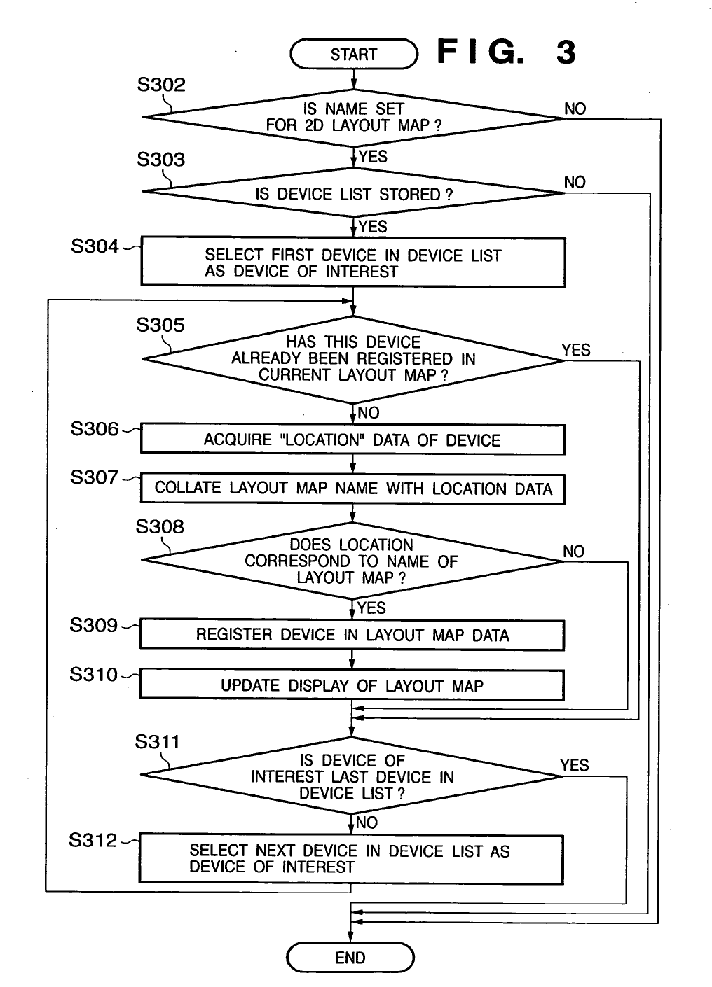

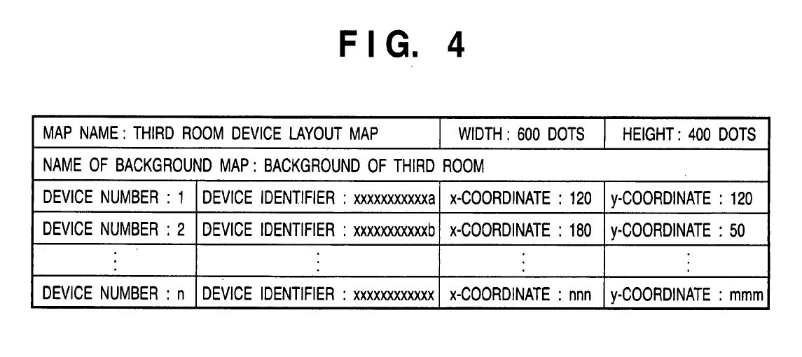

Referring to FIG. 2, reference numeral 201 denotes “2D layout map name” (i.e., a field name indicating an input field 202), which is used by the administrator to input and set the name to be assigned to a 2D layout map displayed on an area 208. The input field 202 is a field where the administrator inputs the name of the 2D layout map. Reference numeral 203 denotes “save & quit”, which is a button used to save 2D layout map data that has been created/edited on this window and to quit the creation/edit job on the window. Reference numeral 204 denotes “cancel & quit”, which is a button used to discard 2D layout map data that has been created/edited on this window and to quit the creation/edit job. Reference numeral 205 denotes “lay out device”, which is a button used to lay out an icon indicating the location of a device on a 2D layout map creation/edit area 208 (hereinafter, abbreviate as “2D layout edit area”) on this window. When the user instructs this button 205, he or she can execute an operation for laying out an icon indicating the location and type of a given device on the 2D layout edit area 208. When the user lays out the icon by executing this operation, this data is saved upon instruction of the “save & quit” button 203. When that data is called in the next job, the device is displayed at the set location on the 2D layout map area 208. Reference numeral 206 denotes “set background image”, which is a button used to designate and display a background map on the 2D layout edit area 208 on this window. Upon instruction of this button 206, a background map can be designated on the 2D layout map area 208. When the user instructs the “save & quit” button 203, information of the designated background map is saved, and is stored in “background map name” of 2D layout map data (FIG. 4). Reference numeral 207 denotes “device automatic registration”, which is a button used to call a function of automatically registering a device on the basis of its location data as a basic operation of this embodiment. When the user instructs this button 207, the device automatic registration function is executed on the basis of the flowchart shown in FIG. 3. The 2D layout edit area 208 displays 2D layout map data on this window, and allows the user to edit/create a device layout while confirming the display. In the example of FIG. 2, the layout of desks, chairs, and the like in an office is illustrated as a background image, and printers of different types are laid out as devices at different locations.

FIG. 3 is a flowchart for explaining the basic operation in the information processing apparatus 100 according to the first embodiment of the present invention. A program that implements this process is stored in the ROM 103 or secondary storage device 106. This basic operation is executed when the user instructs the “device automatic registration” button 207 shown in FIG. 2.

When this process starts, it is checked in step S302 if a name is set for a 2D layout map whose edit process is now in progress. If the name is set, the flow advances to step S303; otherwise, this process ends.

FIG. 4 shows an example of 2D layout map data according to this embodiment, and this data is stored in the RAM 104.

A field “map name” stores the name (in this case, “third room device layout map”) of a 2D layout map, which is assigned to identify this 2D layout map. This name is set using the aforementioned input field 202. This name is checked in step S302 in FIG. 3 above. Fields “width” and “height” that follow “map name” in FIG. 4 indicate the display size of this 2D layout edit area 208 on the window. In the example of FIG. 4, width=600 dots and height=400 dots are set.

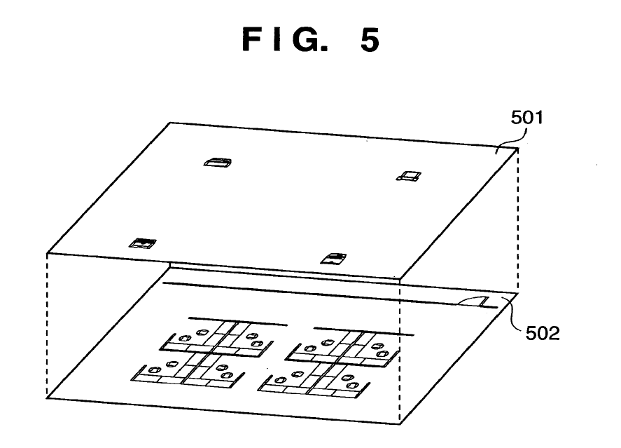

FIG. 5 depicts a view for explaining the logical structure of data which form the 2D layout map data according to this embodiment.

The 2D layout map data according to this embodiment is formed of two layers 501 and 502. The layer 501 is an icon layer on which device icons (printer icons in the example of FIG. 2) are laid out. The layer 502 is a background map layer on which bitmap data of a background map designated by “background map name” in the 2D layout map data (FIG. 4) is pasted. This background map is mainly used to depict the layout of devices that give hints for specifying device positions. The sizes of these two layers 501 and 502 are determined by the values of “width” and “height” designated in the first row of the 2D layout map data.

A field “background map name” in the second row of the 2D layout map data shown in FIG. 4 designates the location of background map data to be pasted onto the background map layer 502.

The third and subsequent rows in the 2D layout map data in FIG. 4 stores data of devices registered on this 2D layout map. Note that a device identifier adopts a MAC address or the like as a globally unique identifier which is assigned to the network interface 111. Alternatively, another identifiable information may be used depending on application fields. In this case, only a device identifier and device type are presented as information of a device which belongs to a device group. However, a format that records various kinds of information used to describe device features may be used. Since icons must be laid out on the 2D layout map, these device data also includes x- and y-coordinates on the window, which express the locations of respective device icons.

The apparatus according to this embodiment displays icons corresponding to devices on the icon layer 501 on the basis of these x- and y-coordinates and device data.

It is then checked in step S303 (FIG. 3) if a device list is stored. If the device list is available, the flow advances to step S304; otherwise, this process ends.

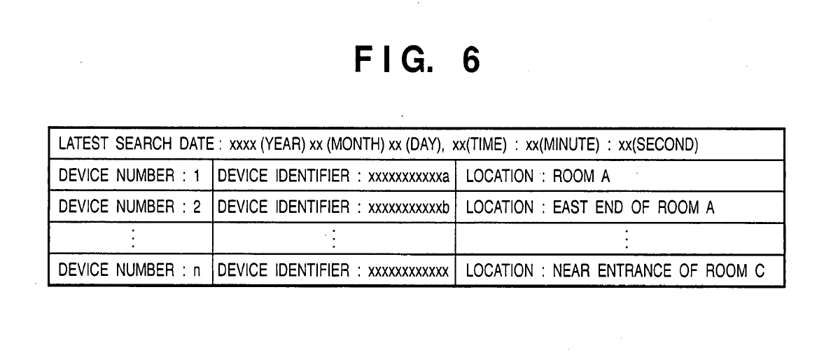

FIG. 6 shows an example of data of the device list used in this embodiment. This device list includes data used to specify devices to be laid out on the layout map.

Referring to FIG. 6, the first row includes “last search execution date”, which is the latest date upon conducting a device search. The second and subsequent rows include a list of devices based on the previous search results. Respective devices are assigned serial device numbers, and the list stores information such as device identifiers used to identify respective devices, data indicating locations, which are set for respective devices, and the like. As can be seen from FIG. 6, the device list shown in FIG. 6 can specify respective devices and their locations on the background map. As a result, when the location of a device corresponds to the name of the layout map, the device is registered in that 2D layout map data, as shown in FIG. 4.

In step S304, the first device registered in the device list is selected as a device of interest. The flow advances to step S305 to check if the current device of interest has already been registered in the 2D layout map whose edit process is now in progress. If the device of interest has already been registered, the flow advances to step S311 to select the next device in the device list as a device of interest; if the device of interest has not been registered yet, the flow advances to step S306 to acquire data of the location set for that device from the device list (FIG. 6). The flow advances to step S307 to collate the acquired location data with the name of the 2D layout map whose edit process is now in progress. It is then determined in step S308 whether the location data corresponds to the 2D layout map. If the location data corresponds to the 2D layout map, the flow advances to step S309; otherwise, the flow advances to step S311 to select the next device in the device list as a device of interest. It may be determined whether or not the location data corresponds to the layout map, by checking if the location data includes the same character string (“room” in the examples of FIGS. 4 and 6) as that included in the layout map name, or may be determined by storing valid names as locations in a table in correspondence with the layout map name, and checking if the device location includes that valid name. In step S309, the data of the current device of interest is registered in the 2D layout map data whose edit process is now in progress. In step S310, the display on the 2D layout map edit window is updated. Upon completion of this update process, the flow advances to step S311.

It is determined in step S311 whether the current device of interest is the last device in this device list. If the device of interest is the last device, this process ends. On the other hand, if the device of interest is not the last device, the flow advances to step S312 to select the next device in the device list as a device of interest. After that, the flow returns to step S305 to repeat the aforementioned processes.

As described above, according to the first embodiment, the administrator of network devices need only input an appropriate name to the input field 202 of “2D layout map name” and instruct the “automatic registration” button 207 on the window shown in FIG. 2. Then, devices, each of which location has character strings that match the 2D layout map name inputted to the name field 202, are automatically selected and registered at the locations of respective devices registered in the device list, and their icons can be displayed on the window, as shown in, e.g., FIG. 2.

In this manner, the need for the operation for manually selecting and registering devices to be registered on the 2D layout map whose edit process is in progress from a large number of devices registered in the device list can be obviated, thus greatly reducing the load on the operator.

### Second Embodiment

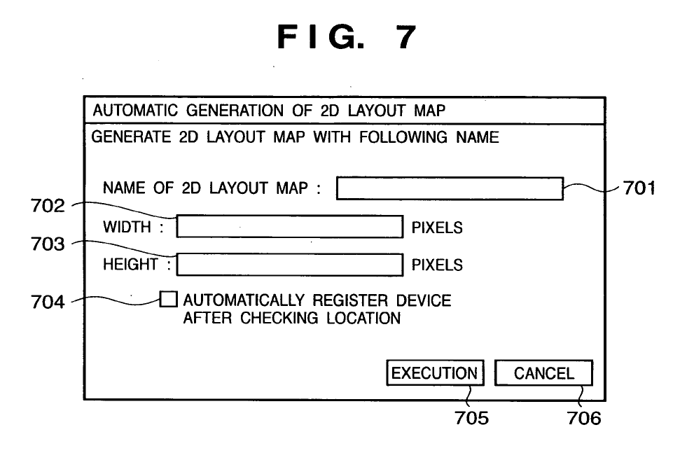

The second embodiment of the present invention will be explained below. The second embodiment is characterized in that devices associated with a given 2D layout map can be automatically laid out and registered by inputting the name of that 2D layout map and instructing automatic registration on a window shown in FIG. 7. Note that the arrangement of the information processing apparatus 100 according to the second embodiment has the same arrangement as that shown in FIG. 1 described in the aforementioned first embodiment. Also, 2D layout map data used in the second embodiment has the same data configuration as that shown in FIG. 4. Furthermore, the 2D layout map to be displayed in the second embodiment has the same layer structure as that shown in FIG. 5. Moreover, device list data used in this embodiment has the same data structure as that shown in FIG. 6.

FIG. 7 shows an example of a 2D new layout map data creation window according to the second embodiment of the present invention.

Referring to FIG. 7, reference numeral 701 denotes “2D layout map name”, which is a field used to input a name assigned to a 2D new layout map to be created. Reference numeral 702 denotes “width”, which is a field used to input a numerical value indicating the width of this 2D layout map. Likewise, reference numeral 703 denotes “height”, which is a field used to input a numerical value indicating the height of the 2D new layout map to be created. Note that these “name”, “width”, and “height” correspond to data in the first row in FIG. 4. Reference numeral 704 denotes a check box which is used to designate whether or not to “automatically register devices after checking their locations”. With this check box, the operator checks location data set for devices, and determines whether or not an automatic registration process is to be executed. If this check box 704 is checked, an automatic registration process to be described later is executed; otherwise, the automatic registration process is skipped. Reference numeral 705 denotes an “execution” key which is used to instruct generation of the 2D layout map after values are input to the fields 701 to 704 and are settled. If the check box 704 is checked when the “execution” key is designated, the automatic registration process is executed. Reference numeral 706 denotes a “cancel” button which is used to instruct cancel of generation of 2D layout map data. When the user instructs this “cancel” button 706, the 2D new layout map generation process is aborted.

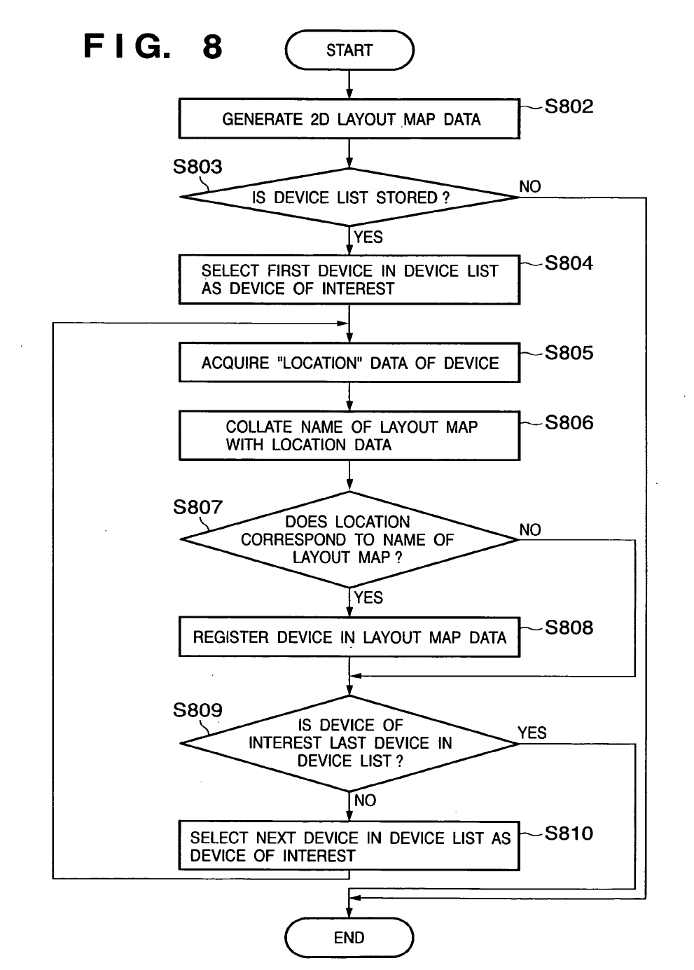

FIG. 8 is a flowchart for explaining a process for registering devices on 2D layout map data in the information processing apparatus 100 according to the second embodiment of the present invention. A program that implements this process is stored in the ROM 103 or secondary storage device 106.

The basic operation in FIG. 8 is executed when the user checks the check box 704 to select “execution of the automatic registration process”, and instructs the “execution” button 705. In step S802, 2D layout map data is generated based on data set in the fields 701 to 704 in FIG. 7. The flow advances to step S803 to check if a device list (FIG. 6) is stored. If no device list is stored, the process ends; otherwise, the flow advances to step S804 to select the first device registered in the device list as a device of interest. The flow advances to step S805 to acquire location data of the current device of interest from that device list. The flow advances to step S806 to collate the acquired location data with the 2D layout map name of the 2D layout map data, which is set in the input field 701. The flow advances to step S807 to check if the location data corresponds to the 2D layout map name, in the same manner as in step S308 above. If the location data corresponds to the 2D layout map name, the flow advances to step S808; otherwise, the flow jumps to step S809 to select the next device in the device list.

In step S808, the current device of interest is registered in the 2D layout map data generated in step S802. The flow then advances to step S809 to check if the current device of interest is the last device registered in this device list. If the device of interest is the last device, this process ends; otherwise, the flow advances to step S810 to select the next device in the device list as a device of interest. After that, the flow returns to step S805 to repeat the aforementioned processes.

As described above, according to the second embodiment, the administrator of network devices needs only input a name in the 2D layout map name input field 701, checks the “automatic registration execution” check button 704, and instructs the execution button 705. Then, devices, each of which has character strings corresponding to the 2D layout map name inputted in the name field 701, are automatically selected and registered in the 2D layout map data at the locations of respective devices registered in the device list.

In this manner, according to the second embodiment, devices to be registered can be automatically selected from a large number of devices registered in the device list, and can be registered in 2D layout map data to be automatically generated. With this process, the load on the operator can be greatly reduced.

### Third Embodiment

The third embodiment of the present invention will be described below. The third embodiment is characterized in that when location data of a given device has been changed, and when layout map name data of the current 2D layout map of interest corresponds to the old location data of that device but does not correspond to new location data, the data of that device is deleted from the current 2D layout map data of interest. The arrangement of the information processing apparatus according to the third embodiment has the same arrangement as that shown in FIG. 1 described in the aforementioned first embodiment. Also, 2D layout map data used in the third embodiment has the same data configuration as that shown in FIG. 4. Furthermore, the 2D layout map to be displayed has the same layer structure as that shown in FIG. 5. Moreover, device list data used in the third embodiment has the same data structure as that shown in FIG. 6.

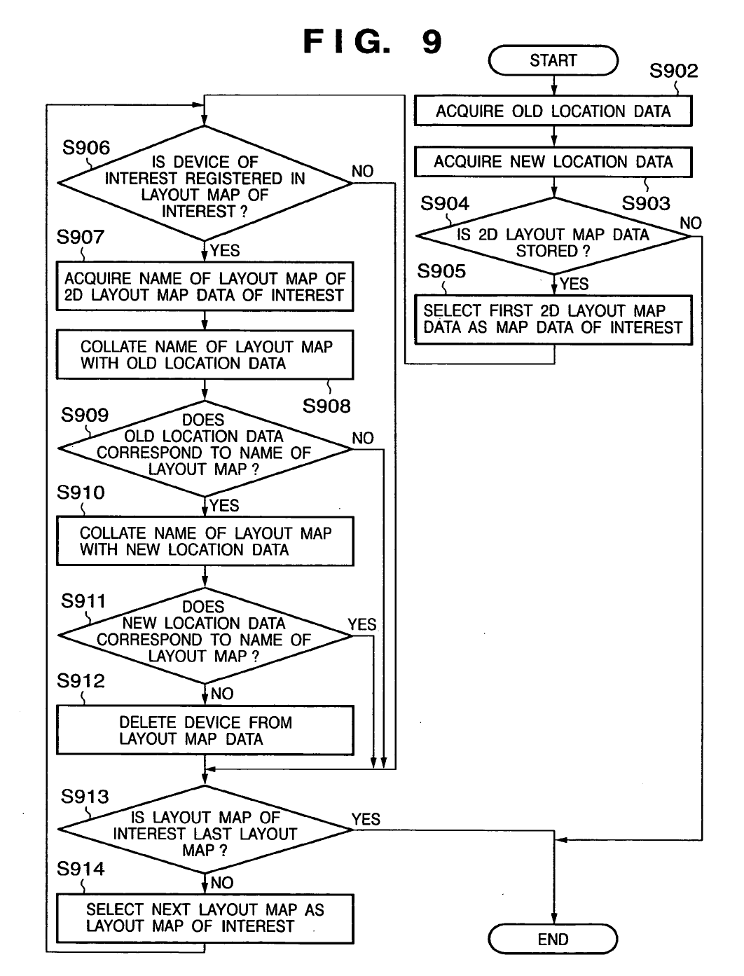

FIG. 9 is a flowchart for explaining the device update process of layout map data in the information processing apparatus according to the third embodiment of the present invention. A program that implements this process is stored in the ROM 103 or secondary storage device 106.

The basic operation according to the third embodiment shown in FIG. 9 is launched and executed when location data set for a device has been changed. The basic operation of the third embodiment will be described below with reference to the flowchart of FIG. 9.

In step S902, old location data, which was set for a device whose location data has been changed, is acquired. The flow advances to step S903 to acquire new location data set for the device of interest. The flow advances to step S904 to check if 2D layout map data are stored in this information processing apparatus 100. If 2D layout map data are stored, the flow advances to step S905; otherwise, this process ends. In step S905, the first one of 2D layout map data is selected as 2D layout map data of interest. It is determined in step S906 whether the device of interest is registered in that 2D layout map data. If the device of interest is registered, the flow advances to step S907; otherwise, the flow branches to step S913 to select the next layout map data.

In step S907, layout map name data is acquired from the 2D layout map data. The flow then advances to step S908 to collate this layout map data with the old location data of that device acquired in step S902. The flow advances to step S909 to check if the 2D layout map name data corresponds to the old location data. If they do not correspond, the flow branches to step S913; otherwise, the flow advances to step S910 to collate the new location data acquired in step S903 with the layout map name data. The flow advances to step S911. If it is determined in step S911 that that location data corresponds to the layout map name, since the device data need not be deleted, the flow jumps to step S913; otherwise, the flow advances to step S912. This means that the layout map name data of the current 2D layout map of interest corresponds to the old location data of the device of interest, but does not correspond to its new location data. Hence, based on this, data of the device of interest is deleted from the current 2D layout map data of interest. Upon completion of this deletion process, the flow advances to step S913 to check if the current 2D layout map data of interest is the last one of the 2D layout map data. If the 2D layout map data of interest is not the last data, the flow advances to step S914 to select the next 2D layout map as a 2D layout map of interest. After that, the flow returns to step S906 to repeat the process. On the other hand, if the 2D layout map data of interest is the last data, this process ends. Note that the checking processes in steps S909 and S911 are executed in the same manner as in step S308 in FIG. 3 above.

As described above, according to the third embodiment, when the administrator of network devices only changes the location of a specific device, data of that device can be automatically deleted from the 2D layout map data in which that device was registered previously. Hence, the need for the sequence for retrieving and deleting data of the device of interest by referring to and editing individual 2D layout map data can be obviated.

In addition, according to the third embodiment, only when the location data before the change corresponds to the 2D layout map name data (YES in step S909), the device of interest is deleted from the layout map. For this reason, when the 2D layout map name is not related to location data, data of that device is never automatically deleted from the layout map data. Hence, data of the laid-out device can be prevented from being inadvertently deleted from the 2D layout map data.

Furthermore, according to the third embodiment, since the location data of the device of interest after the change is also collated with the 2D layout map name data, in a case where both the location data before and after the change correspond to the 2D layout map name, the device is not deleted. Therefore, in a case where the new location data has been slightly changed, data of the device can be prevented from being unwantedly deleted from the 2D layout map.

That is, according to the third embodiment, the need for the sequence for retrieving data of each individual device, the location of which has been changed, from a large number of device data registered in the device list, and deleting it from the 2D layout map data based on the changed contents can be obviated, and a desired process can be automatically executed. Hence, the labor required to manage devices can be greatly reduced.

### Fourth Embodiment

The fourth embodiment of the present invention will be described below. The fourth embodiment is characterized in that by changing only location data of a device, data of that device can be automatically registered in a layout map, whose layout map name corresponds to the new location data, of data of 2D layout maps in which that device is not registered. The arrangement of the information processing apparatus 100 according to the fourth embodiment has the same arrangement as that shown in FIG. 1 described in the aforementioned first embodiment. Also, 2D layout map data used in the fourth embodiment has the same data structure as that shown in FIG. 4. Furthermore, the 2D layout map to be displayed in the fourth embodiment has the same layer structure as that shown in FIG. 5. Moreover, device list data used in the fourth embodiment has the same data structure as that shown in FIG. 6.

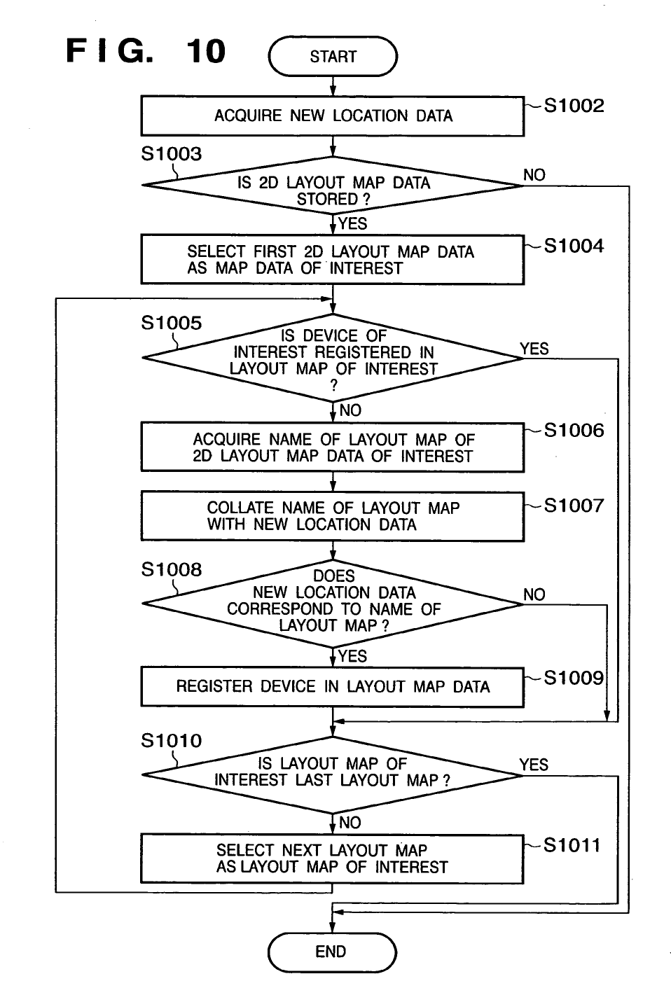

FIG. 10 is a flowchart for explaining the process for registering updated device data in layout map data in the information processing apparatus 100 according to the fourth embodiment of the present invention. A program that implements this process is stored in the ROM 103 or secondary storage device 106.

The basic operation according to the fourth embodiment shown in FIG. 10 is launched and executed in a case where location data set for a given device has been changed using the device management window. In step S1002, new location data set for that device is acquired. The flow advances to step S1003 to check if the information processing apparatus 100 according to the fourth embodiment currently has 2D layout map data. If the apparatus has 2D layout data, the flow advances to step S1004; otherwise, this process ends.

In step S1004, the first layout map of available 2D layout map data is selected as a layout map of interest. The flow advances to step S1005 to check if the device of interest is registered in the 2D layout map data of interest. If the device of interest has already been registered, the flow branches to step S1010 to select the next layout map data; otherwise, the flow advances to step S1006 to acquire layout map name data of the 2D layout map data of interest. The flow advances to step S1007 to collate that layout map name data with the new location data of that device acquired in step S1002. The flow advances to step S1008. If it is determined in step S1008 as a result of collation that they correspond to each other, the flow advances to step S1009 to register the device of interest in the current 2D layout map data of interest. The flow then advances to step S1010. On the other hand, if it is determined in step S1008 if the two data do not correspond, the flow advances to step S1010 to check if the current 2D layout map data of interest is the last layout map data. If the 2D layout map data of interest is not the last layout map data, the flow advances to step S1011 to select the next one of available 2D layout maps as a layout map of interest, and the flow returns to step S1005 to repeat the aforementioned process. On the other hand, if it is determined in step S1010 that the 2D layout map data of interest is the last data, the process ends.

According to the fourth embodiment, in a case where the administrator of network devices has changed the location of a specific device, data of that device can be automatically registered in a layout map, whose layout map name corresponds to the new location data, of 2D layout map data in which that device is not registered, by changing only the location data. In this manner, by changing only the location data of a device, that device can be automatically registered in the corresponding 2D layout map data. As described above, the layout map name of 2D layout map data and the location data can be organically engaged and, as a result, the labor required to manage devices can be greatly reduced.

### Fifth Embodiment

The fifth embodiment of the present invention will be described below. The fifth embodiment is characterized in that in case where the location of a specific device has been changed, data of the device can be automatically deleted from data of a 2D layout map in which the data of the device was previously registered, by changing that location data. The arrangement of the information processing apparatus according to the fifth embodiment is the same as that in FIG. 1 described in the aforementioned first embodiment, and the 2D layout map data, 2D layout map, and device list data used in the fifth embodiment are the same as those in the above embodiments.

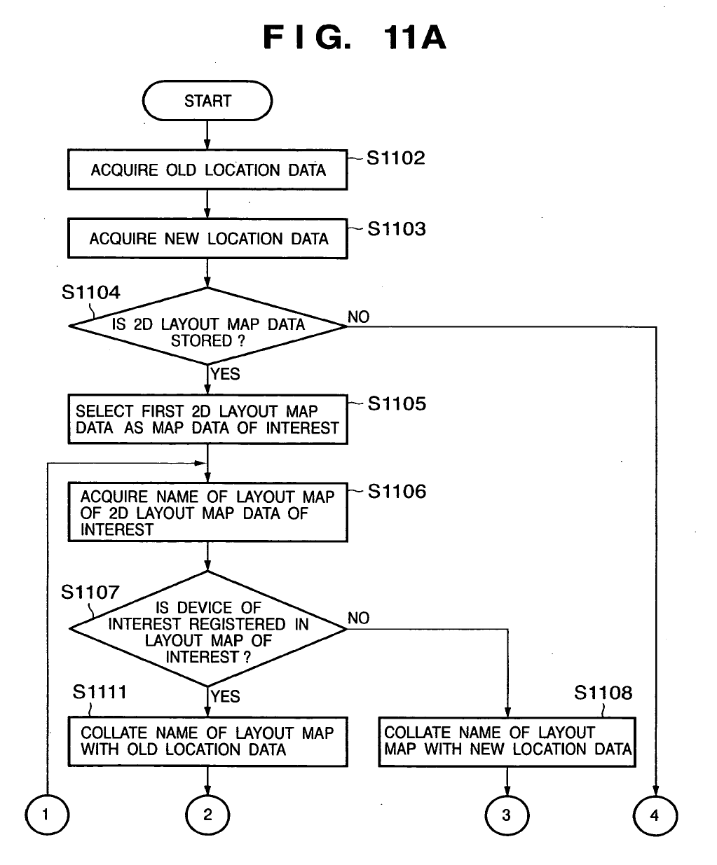

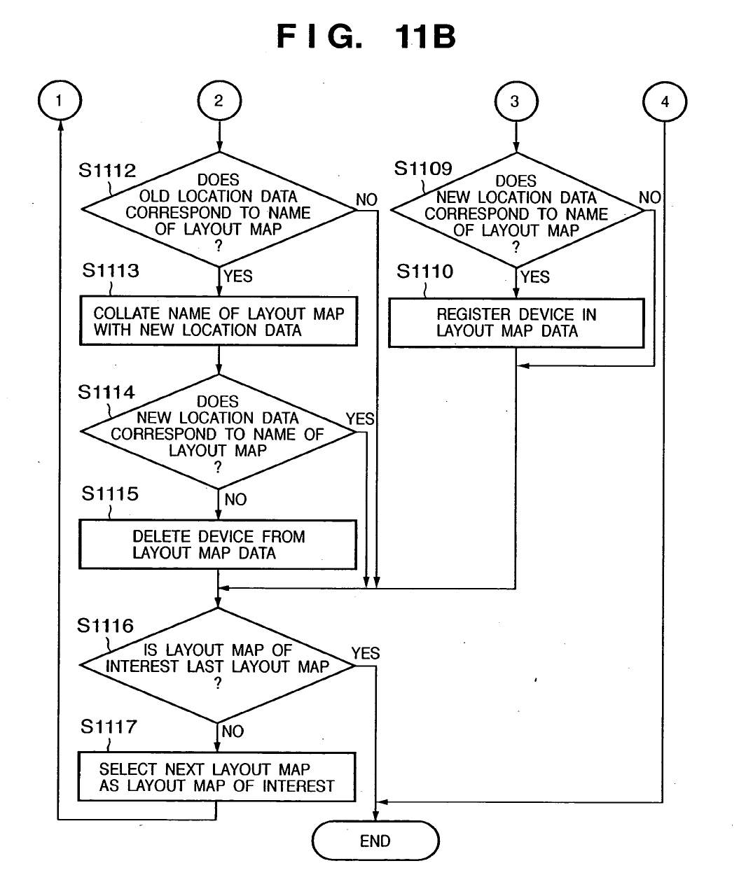

FIGS. 11A and 11B are flowcharts showing the process for updating device data of layout map data in the information processing apparatus 100 according to the fifth embodiment of the present invention. A program that implements this process is stored in the ROM 103 or secondary storage device 106.

The basic operation shown in FIGS. 11A and 11B is launched and executed in a case where location data set for a device has been changed using the device management window. In step S1102, old location data of the device before the change is acquired. The flow advances to step S1103 to acquire new location data of the device after the change. The flow advances to step S1104 to check if the information processing apparatus 100 according to the fifth embodiment has 2D layout map data. If the apparatus 100 has the 2D layout map data, the flow advances to step S1105; otherwise, this process ends.

In step S1105, the first one of 2D layout map data of this information processing apparatus 100 is selected as 2D layout map data of interest. The flow then advances to step S1106 to acquire the layout map name of the current 2D layout map data of interest. The flow advances to step S1107 to check if the device whose data has been changed is registered in the current 2D layout map data of interest. If the device data is not registered, the flow advances to step S1108; otherwise, the flow advances to step S1111. In step S1108, the layout map name of the current 2D layout map data of interest is collated with the new location data acquired in step S1103. It is determined in step S1109 whether the layout map name corresponds to the location data. If they corresponds, the flow advances to step S1110, and the device data is registered in the current 2D layout map data of interest. After then, the flow jumps to step S1116. On the other hand, if it is determined in step S1109 that the two data do not correspond, the flow advances to step S1116.

If it is determined in step S1107 that the device of interest is registered in the layout map data of interest, the flow advances to step S1111 to collate the layout map name of the current 2D layout map data of interest with the old location data acquired in step S1102. It is determined in step S1112 whether the layout map name corresponds to the old location data. If they do not correspond, the flow jumps to step S1116; otherwise, the flow advances to step S1113 to collate the layout map name of the current 2D layout map data of interest with the new location data acquired in step S1103. The flow advances to step S1114 to determine whether the layout map name corresponds to the location data. If it is determined in step S1114 that they do not correspond, then the flow advances to step S1115, and that device is deleted from the current layout map data of interest. After then, the flow advances to step S1116. On the other hand, if they correspond, then the flow branches to step S1116 without any process. It is determined in step S1116 whether the current 2D layout map data of interest is the last one of the 2D layout map data. If the 2D layout map data of interest is not the last data, the flow advances to step S1117 to select the next layout map data of available 2D layout map data as layout map data of interest, and the flow then returns to step S1106 to repeat the aforementioned process. On the other hand, if it is determined in step S1116 that the 2D layout map data of interest is the last data, this process ends. Note that the checking processes in steps S1109, S1112, and S1114 are executed in the same manner as in step S308 in FIG. 3 above.

As described above, according to the fifth embodiment, in a case where the administrator of network devices has changed the location of a specific device, the corresponding data of the device can be automatically deleted from 2D layout map data in which that device was registered previously, by changing only its location data. In this manner, the need for the sequence for retrieving and deleting data of the device of interest by referring to and editing individual 2D layout map data upon updating device data can be obviated.

In addition, according to the fifth embodiment, only in a case where the location data before change corresponds to the 2D layout map name data (YES in step S1112), the device of interest is deleted from that layout map. For this reason, in a case where the 2D layout map name is not related to location data, the data of the device is never deleted. Hence, the data of the laid-out device on the 2D layout map can be prevented from being inadvertently deleted from the 2D layout map data.

Furthermore, according to the fifth embodiment, since the location data of the device of interest after change is also collated with the 2D layout map name data, in a case where both the location data before and after the change correspond to the 2D layout map name, the data of device is not deleted. Therefore, even in a case where the new location data has undergone only a small change, the data of the device can be prevented from being unwantedly deleted from the 2D layout map.

Moreover, according to the fifth embodiment, data of the device is automatically registered in the layout map data of 2D layout map data in which that device is not registered, in a case where the new location data of the device corresponds to the name of the layout map data.

In this manner, by only changing the location data of a device, the need for the sequence for retrieving data of each individual device, the location of which has been changed, from a large number of device data registered in the device list, and deleting it from the 2D layout map data based on the contents of the change can be obviated, and the device can be automatically registered in the corresponding 2D layout map data. In addition, the name of the 2D layout map data and the location data can be organically engaged. As a result, the labor required to manage devices can be greatly reduced.

### Sixth Embodiment

The sixth embodiment of the present invention will be described below. The arrangement of the information processing apparatus according to the sixth embodiment is the same as that in FIG. 1 described in the aforementioned first embodiment. The 2D layout map data, 2D layout map, and device list data in the sixth embodiment are the same as those in the above embodiments.

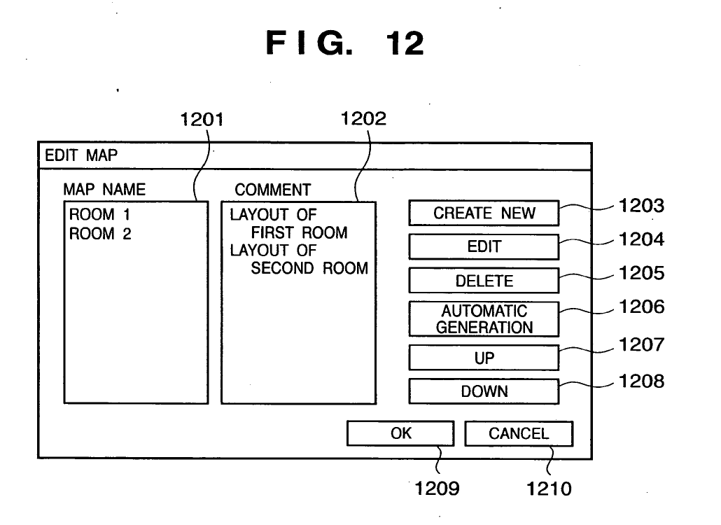

FIG. 12 depicts a view for explaining an example of a 2D layout map data management window in the information processing apparatus 100 according to the sixth embodiment of the present invention.

Referring to FIG. 12, reference numeral 1201 denotes a list display field of 2D layout map names. Reference numeral 1202 denotes a list display field of comments which are given to 2D layout maps corresponding to the layout map names displayed in the name list field 1201. Reference numeral 1203 denotes a “new creation” button which is used to create a new 2D layout map. Reference numeral 1204 denotes an “edit” button, which is used to edit 2D layout map data selected from the 2D layout map list field 1201. Reference numeral 1205 denotes a “delete” button used to delete 2D layout map data selected from the 2D layout map list field 1201. Reference numeral 1206 denotes an “automatic generation” button, which is used to launch a process for automatically generating 2D layout map data from location data, as will be described below in the sixth embodiment. Reference numeral 1207 denotes an “up” button used to shift upward 2D layout map data to be selected from the 2D layout map list field 1201 by one in the order on the list field 1201. Reference numeral 1208 denotes a “down” button used to shift downward 2D layout map data to be selected from the 2D layout map list field 1201 by one in the order on the list field 1201. Reference numeral 1209 denotes an “OK” button used to save the edit result of 2D layout map data, and to quit the process. Reference numeral 1210 denotes a “cancel” button used to discard the edit result of 2D layout map data, and to quit the process.

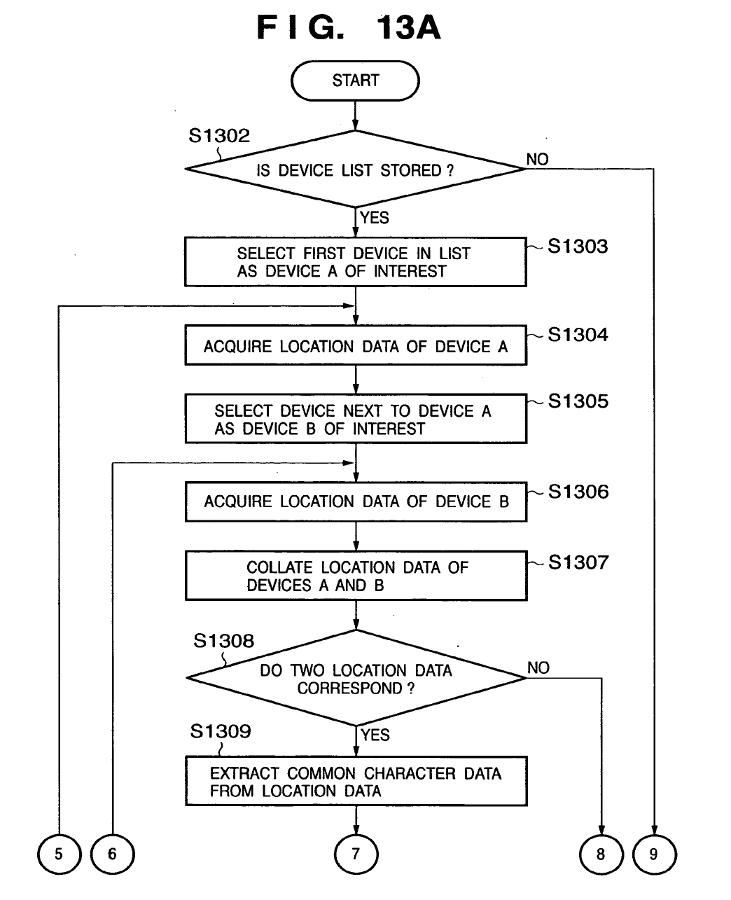

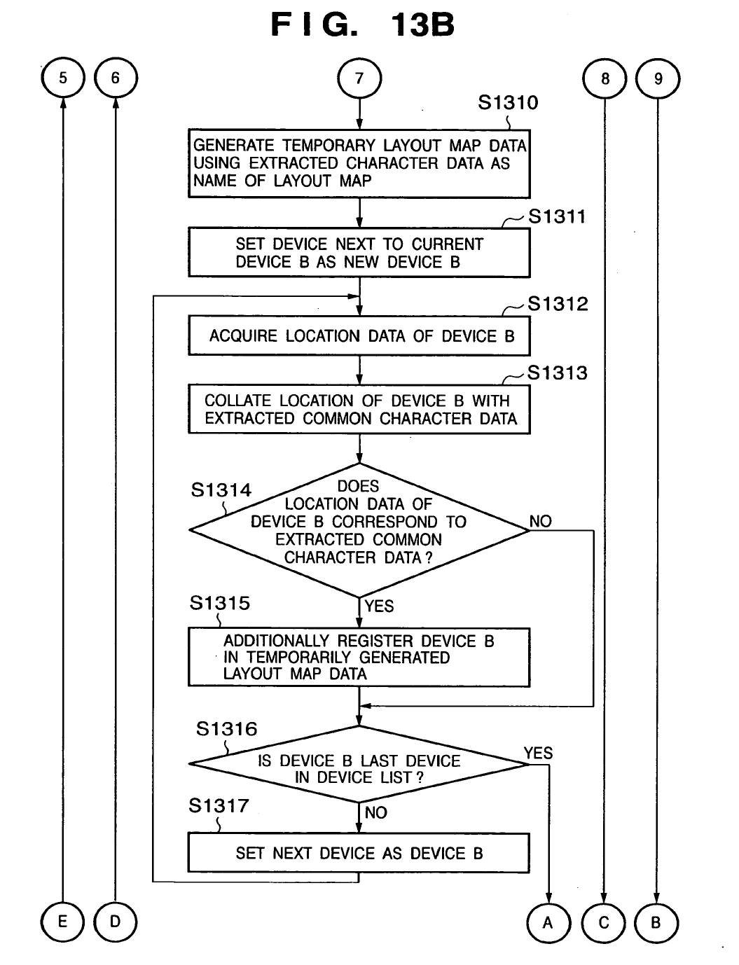

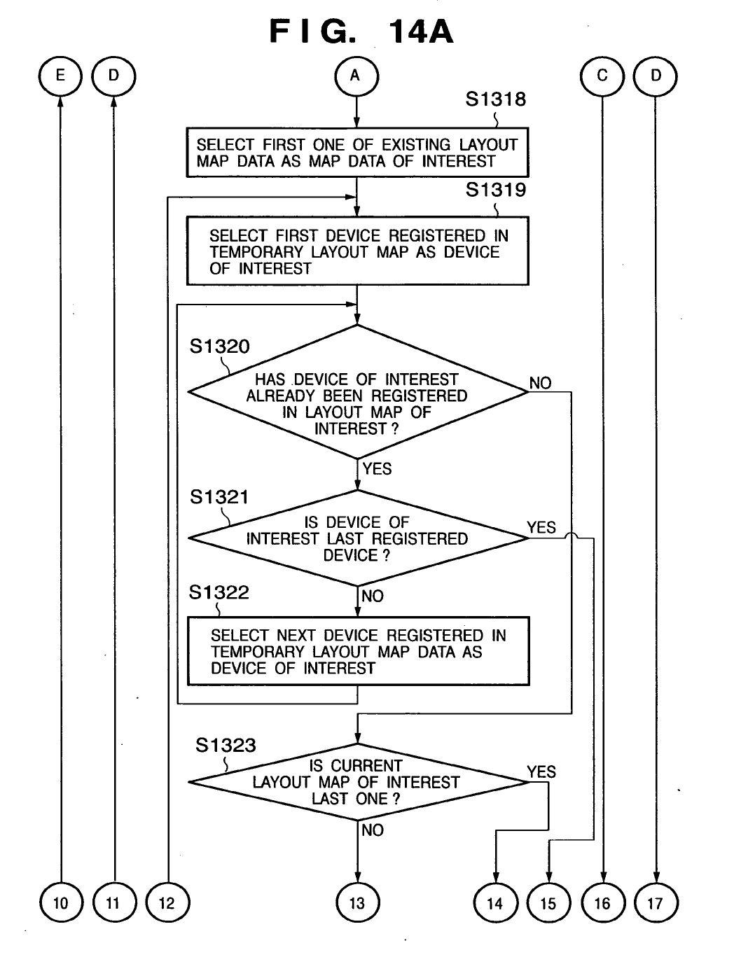

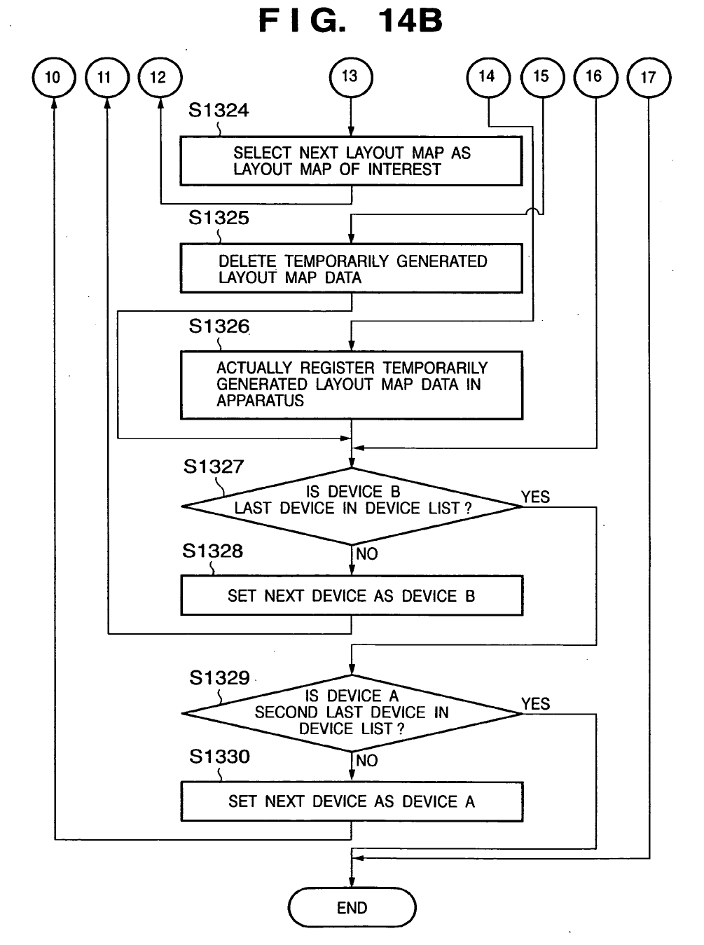

FIGS. 13A and 13B and FIGS. 14A and 14B are flowcharts showing the basic operation of the information processing apparatus according to the sixth embodiment of the present invention. A program that implements this process is stored in the ROM 103 or secondary storage device 106.

This basic operation is launched and executed when location data set for a given device has been changed using the device management window. It is determined in step S1302 whether the information processing apparatus 100 searches for one or more devices and has a device list. If no device list is stored, this process ends. If a device list is stored, the flow advances to step S1303 to set the first device listed up in the device list as device A (i.e., a device of interest). The flow advances to step S1304 to acquire the location data of device A. The flow advances to step S1305 to set a device next to device A on the device list as device B. The flow advances to step S1306 to acquire the location data of the device B. The flow advances to step S1307 to collate the location data of the device A with that of the device B. The flow advances to step S1308 to determine as a result of collation whether the two location data correspond. If the two location data correspond, the flow advances to step S1309; otherwise, the flow jumps to step S1327 (FIG. 14B). This determination process is implemented by checking if the location data of the two devices have common character data.

In step S1309, the common character data is extracted as a result of collation between the location data of the devices A and B. The flow advances to step S1310 to generate temporary 2D layout map data having the extracted common character data as a layout map name. The flow advances to step S1311 to set a device next to the current device B as new device B. The flow advances to step S1312 to acquire the location data of the device set as the new device B. The flow advances to step S1313 to collate the location data of the new device B with the common character data extracted in step S1309. The flow advances to step S1314 to determine whether the location data of the new device B corresponds to the common character data. If they correspond, the flow advances to step S1315, and the new device B is additionally registered in the temporary layout map data generated in step S1310. The flow then advances to step S1316. On the other hand, if it is determined in step S1314 that the two data do not correspond, the flow jumps to step S1316 without any process.

It is determined in step S1316 whether the current device B (new device B in S1312) of interest is the last device in the device list. If the current device B is not the last device, the flow advances to step S1317 to set a device next to the current device B as new device B. The flow then returns to step S1312 to repeat the aforementioned process.

If it is determined in step S1316 that the current device B is the last device, the flow jumps to step S1318 (FIG. 14A) to select the first one of 2D layout map data, which have already been registered in this apparatus. In the current state, some of devices listed in the device list are registered in the temporarily generated layout map data. The flow advances to step S1319 to select the first one of devices which are currently registered in the temporarily generated layout map data as a device of interest. The flow advances to step S1320 to determine whether the current device of interest has already been registered in the current layout map data of interest. If that device has already been registered, the flow advances to step S1321; otherwise, the flow jumps to step S1323. It is determined in step S1321 whether the current device of interest is the last device registered in the temporarily generated layout map data. If the device of interest is not the last device, the flow advances to step S1322 to select the next device currently registered in the temporarily generated layout map data as a device of interest. The flow then returns to step S1320 to repeat the aforementioned process.

On the other hand, if it is determined in step S1320 that the current device of interest has not been registered in the current layout map data of interest, the flow jumps to step S1323 to determined whether the current layout map data of interest is the last layout map data registered in the information processing apparatus 100. If the layout map data of interest is not the last data in step S1323, the flow advances to step S1324 to select the next layout map data as layout map data of interest, and the flow returns to step S1320 to repeat the aforementioned process. On the other hand, if it is determined in step S1323 that the layout map data of interest is the last data, the flow jumps to step S1326.

Also, if it is determined in step S1321 that the current device of interest is the last device registered in the temporarily generated layout map data, the flow jumps to step S1325. In this case, since layout map data which has been currently registered in the apparatus 100 includes a layout map in which all the devices are registered in the temporarily generated layout map data, it is determined that data equivalent to the temporarily generated layout map data has been already registered, and the temporarily generated layout map data is deleted. The flow jumps to step S1327.

If it is determined in step S1323 that the layout map data of interest is the last data, the flow jumps to step S1326. In this case, since layout map data which are currently registered in the apparatus 100 does not include any layout map in which all the devices are registered in the temporarily generated layout map data, the temporarily generated layout map data is registered in this apparatus 100, and the flow advances to step S1327. It is determined in step S1327 whether the device set as device B is the last device registered in the device list. If the device B is not the last device, the flow advances to step S1328 to set the next device as device B, and the flow returns to step S1306 (FIG. 13A) to repeat the process. On the other hand, if it is determined in step S1327 that device B is the last device, the flow jumps to step S1329 to determine whether the device set as device A is the second last device registered in the device list. If device A is not the second last device, the flow advances to step S1330 to set a device next to current device A as new device A, and the flow returns to step S1304 (FIG. 13A) to repeat the abovementioned process. On the other hand, if device A is the second last device in step S1329, the automatic generation process of all 2D layout map data ends, and the control returns to the processing loop of the original 2D layout map management window (FIG. 12).

As described above, according to the sixth embodiment, the network administrator can automatically generate 2D layout map data in which all devices having common data are registered by obviating the need for a job for checking location data set for devices one by one, extracting common data to create new 2D layout map data, and registering devices having the common data one by one.

In the automatic generation process, the contents of the already registered 2D layout data are checked, and in a case where layout map data in which the same data of device is registered is found, automatic generation of the layout map data is canceled. Hence, layout data including identical contents can be avoided from being endlessly generated.

In this manner, management of network devices using the 2D layout map is facilitated very match, and the load on the network administrator can be greatly reduced.

As described above, according to the sixth embodiment, the apparatus which manages devices connected to the network can automatically register or delete device data in or from 2D layout map data with reference to location data set for devices upon execution of device management using a 2D layout map. Since 2D layout map data is automatically generated, network management is facilitated, and the administrator's labor can be greatly reduced. In this manner, the load on the administrator due to network management can be reduced, and the network management efficiency can be improved.

### Seventh Embodiment

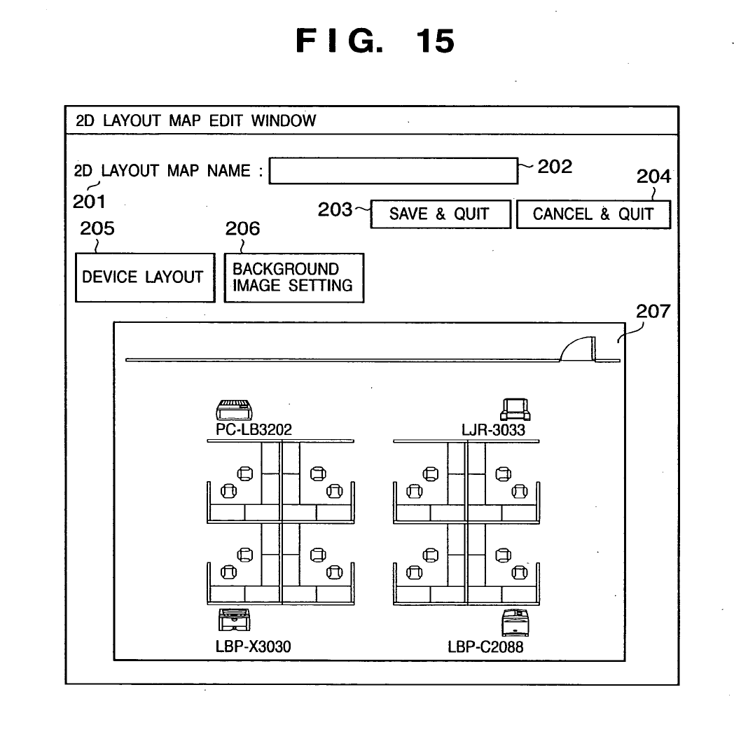

FIG. 15 shows an example of a 2D layout map edit window according to the seventh embodiment of the present invention, and the same reference numerals in FIG. 15 denote parts common to those in FIG. 2 above. The window shown in FIG. 15 is substantially the same as that in the aforementioned first embodiment, except that the “device automatic registration” button 207 in FIG. 2 is omitted, and a description thereof will be omitted.

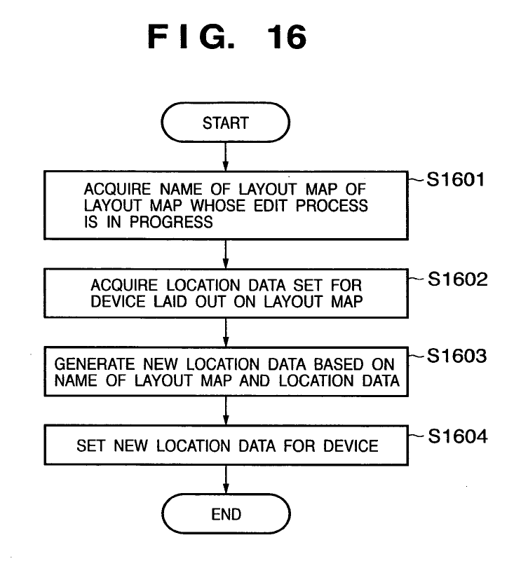

FIG. 16 is a flowchart for explaining the process for generating new location data of a device, in a case where the device is laid out on a layout map in the information processing apparatus 100 according to the seventh embodiment of the present invention. A program that implements this process is stored in the ROM 103 or secondary storage device 106, and is executed under the control of the CPU 101.

This process is called and executed when a device is to be laid out on the edit area 207 of the layout map in FIG. 15 upon instruction of the “device layout” button 205 in FIG. 15.

In step S1601, the layout map name of 2D layout map data whose edit process is now in progress is acquired. The flow advances to step S1602 to acquire location data set for a device which is currently laid out on the layout map. The flow advances to step S1603 to generate new location data of the device on the basis of the layout map name acquired in step S1601 and the location data acquired in step S1602. The flow then advances to step S1604 to set the new location data for that device, thus ending this process.

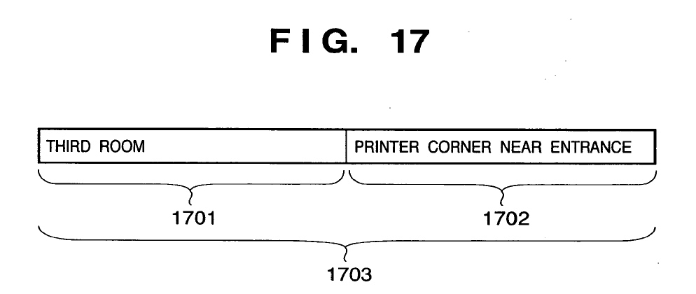

FIG. 17 depicts a view for explaining an example of generation of new location data from the layout map name and location data according to the seventh embodiment.

Referring to FIG. 17, reference numeral 1701 denotes a layout map name which is “third room” in this case. Reference numeral 1702 denotes location data which indicates originally set location data, and is “printer corner near entrance”. Reference numeral 1703 denotes data which is to be generated as new location data.

According to the seventh embodiment, when a device is laid out on a 2D layout map, a location specified by adding the name of the 2D layout map to an originally set character string as the location of the device is set for the location data of the device by the process shown in FIG. 16. Since the 2D layout map name normally adopts the name of a location, the location data of a device is appended with data of the location indicated by the layout map name of the 2D layout map. That is, in the example of FIG. 17, in a case where the device is added to the 2D layout map “third room”, its location data set as “printer corner near entrance” is changed to “third room: printer corner near entrance”. In this way, the location of the device can be clearly recognized.

### Eighth Embodiment

The eighth embodiment of the present invention will be described below. The eighth embodiment is characterized in that new location data is generated using only the name of a layout map of 2D layout map data without using any location data originally set for a device as the new location data to be generated. The arrangement of the apparatus according to the eighth embodiment is the same as that shown in FIG. 1 above. Also, the 2D layout map data edit/creation window in the eighth embodiment has the same configuration as that shown in FIG. 15.

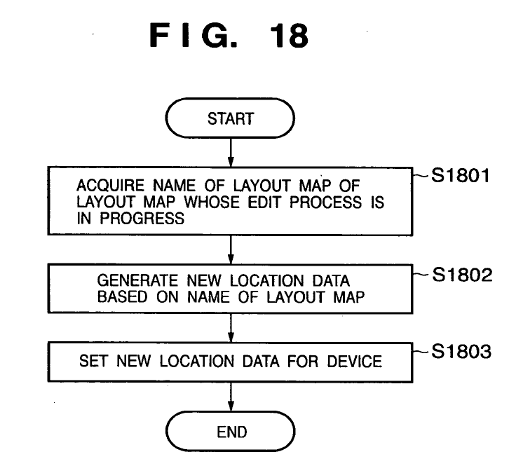

FIG. 18 is a flowchart showing the processing sequence in the information processing apparatus according to the eighth embodiment of the present invention.

This process is executed when the user instructs the “device layout” button 205, designates a device and lays out a device icon on the edit area 207 on the 2D layout map edit/creation window in FIG. 15.

In step S1801, the layout map name of 2D layout map data whose edit process is now in progress is acquired. The flow advances to step S1802 to generate data, which is to be used as new location data, on the basis of the layout map name acquired in step S1801. The flow then advances to step S1803 to set the new location data for the device. Upon completion of this process, the process of this flow ends.

As described above, according to the eighth embodiment, new location data is generated using only the layout map name of the 2D layout map without using any location data originally set for a given device as the new location data to be generated. This process has a disadvantage in that all location data of laid-out devices have similar contents, but has an advantage in that the process can be simplified, and in a case where insignificant data is set as original location data, the administrator need not manually remove that insignificant data later.

As described above, according to the eighth embodiment, since location data set for a device can be rewritten simultaneously with a job for laying out the device in 2D layout map data, the administrator's labor can be greatly reduced. Since the 2D layout map data has a comprehensible name, the meaning of the set location data is also comprehensible, and can be easily understood by the user.

### Ninth Embodiment

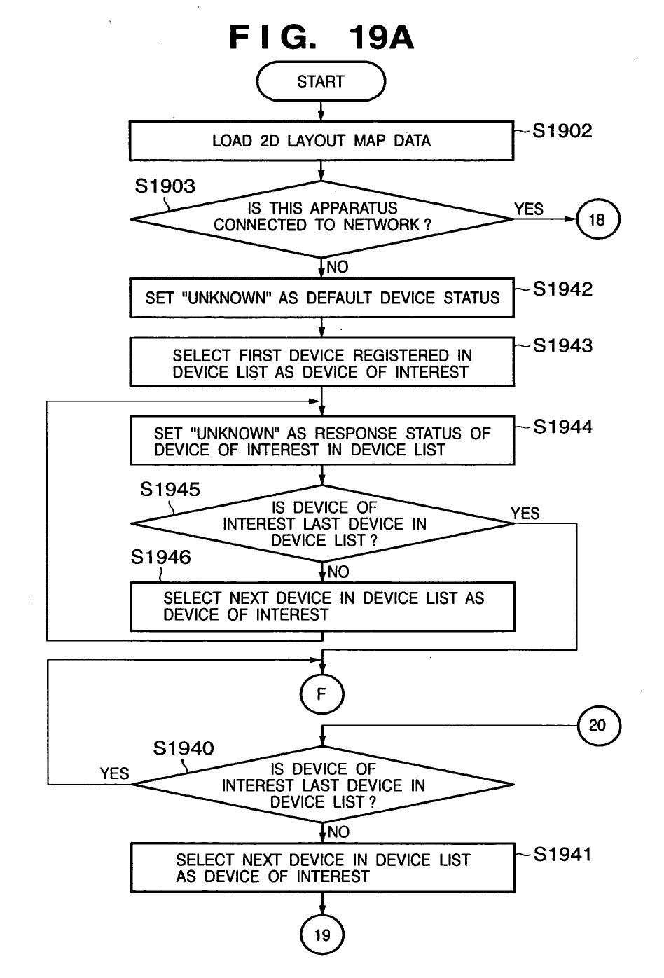

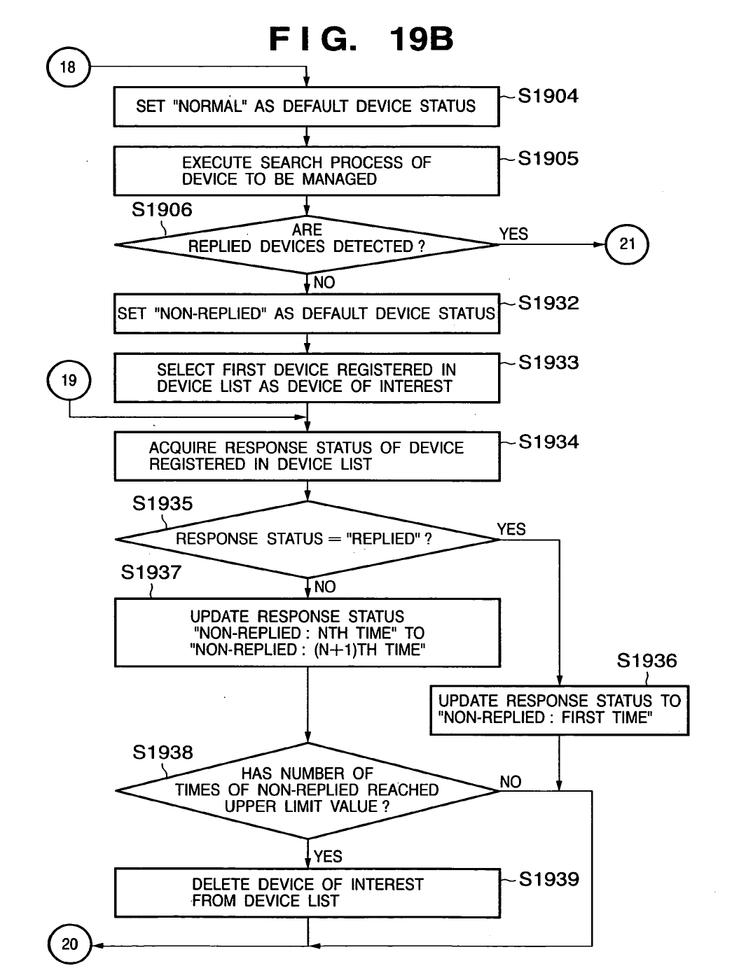

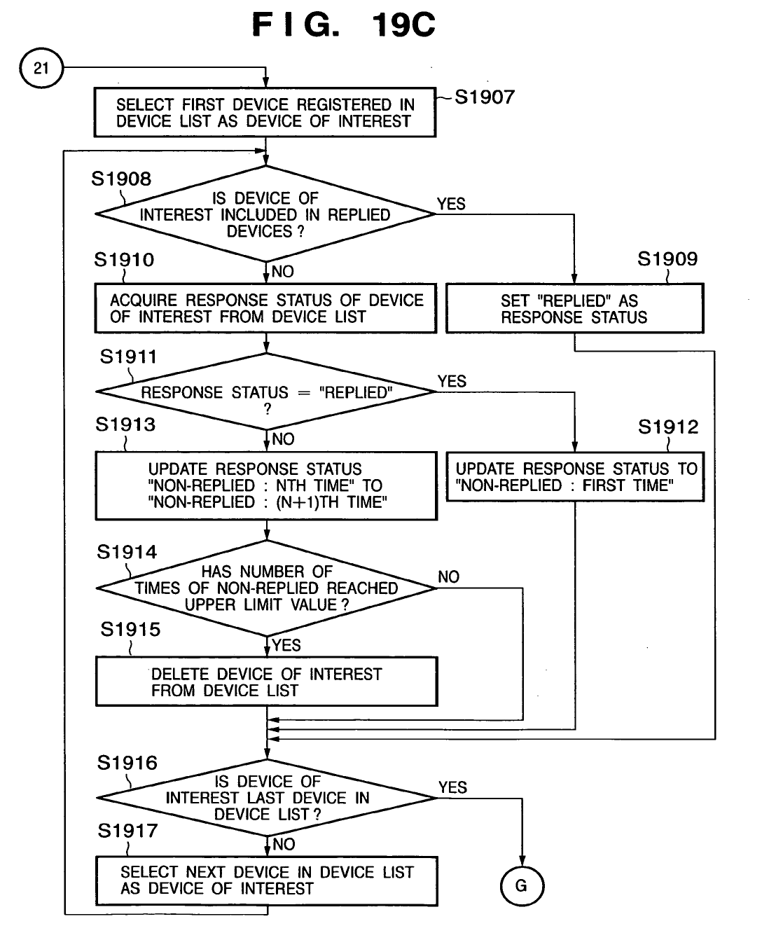

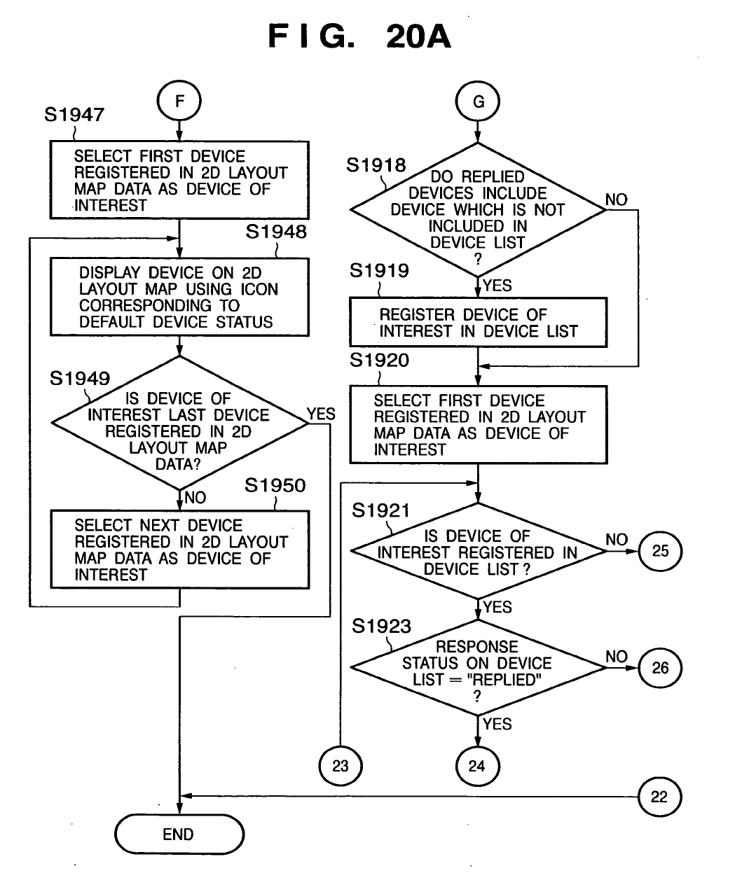

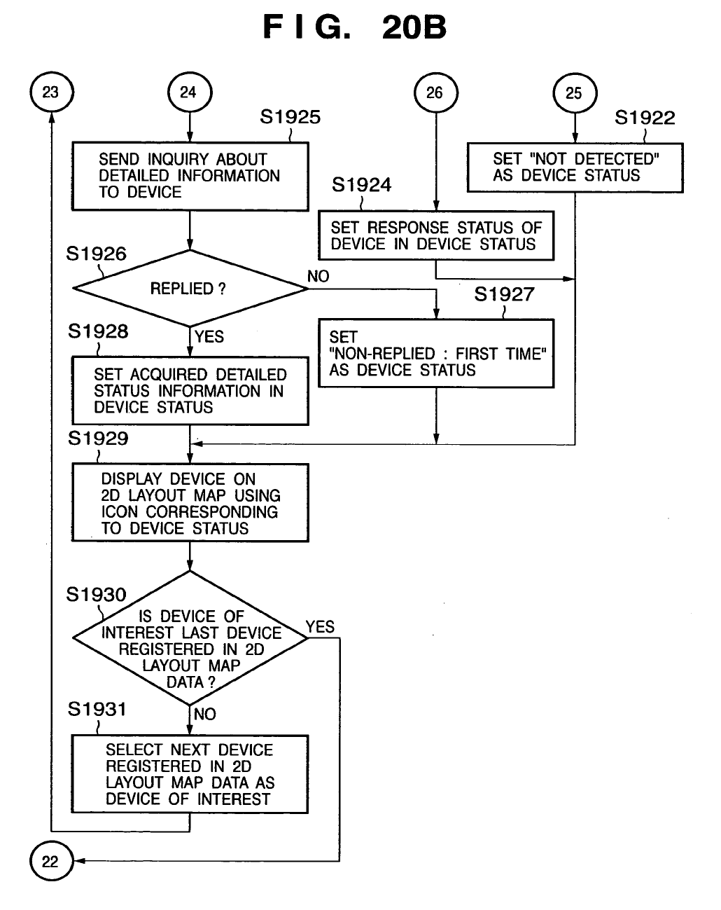

FIGS. 19A to 19C and FIGS. 20A and 20B are flowcharts for explaining the basic operation in the apparatus according 100 to the ninth embodiment of the present invention. A program that implements this process is stored in the ROM 103 or secondary storage device 106, and is executed under the control of the CPU 101. Note that the arrangement of the apparatus according to the ninth embodiment is the same as that shown in FIG. 1, and a description thereof will be omitted.

When the process starts, 2D layout map data to be displayed, which is stored in the secondary storage device 106, is acquired in step S1902.

This 2D layout map data lists up information associated with the 2D layout map data such as a map name and the like, information of a background to be displayed on the map, and information of devices to be laid out, as has been explained previously with reference to FIG. 4. Also, the 2D layout map data has the logical structure which has been explained with reference to FIG. 5 above. That is, the location of background data to be pasted on the layer 502 is designated in the “background map name” field in the 2D layout map data in FIG. 4. Also, data of devices registered in this 2D layout map data are stored in “device number” fields in the 2D layout map data in FIG. 4. Note that a device identifier adopts a MAC address or the like as a globally unique identifier which is assigned to the network interface 111. Alternatively, another identifiable information may be used depending on application fields. In this case, only a device identifier and device type are presented as information of a device which belongs to a device group. However, a format including various kinds of information used to describe device features may be used. Since icons must be laid out on the 2D layout map, these device data also store x- and y-coordinates on the window, which express the locations of respective device icons. The apparatus 100 according to the ninth embodiment displays icons corresponding to devices on the icon layer 501 on the basis of these x- and y-coordinates and device data.

After the 2D layout map data is acquired in step S1902 in this way, the flow advances to step S1903 to determine whether the apparatus 100 is connected to the network 112. If the apparatus is connected, the flow branches to step S1904; otherwise, the flow advances to step S1942.

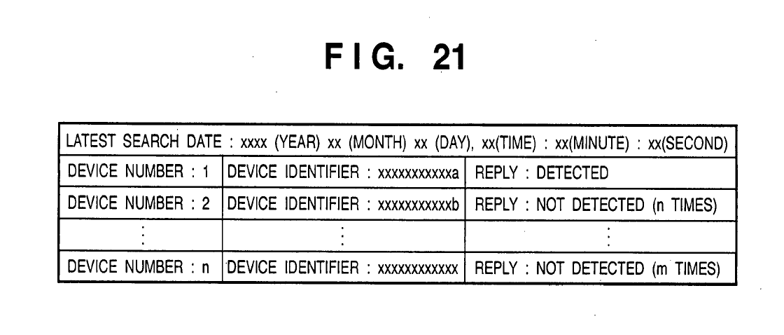

In step S1904, “normal” is set as default device status. The flow advances to step S1905 to execute a search process of devices to be managed. After execution of this search process, the search result is checked in step S1906. If replied devices are detected, the flow advances to step S1907; otherwise, the flow jumps to step S1932. In step S1907, the first device registered in a device list is selected as a device of interest. Note that the device list is a list stored in the secondary storage device 106, and has a data structure shown in FIG. 21.

Referring to FIG. 21, the first row records “last search execution date”. In this field, the latest date upon conducting a device search is written. The second and subsequent rows record a list of replied devices as a result of previous search processes. Respective devices are assigned serial device numbers, and the list stores information such as device identifiers used to identify respective devices, response status, and the like. When the first device is to be selected as a device of interest, device information with the device number “1” is extracted, and is used as “device of interest”.

After the first device is selected as the device of interest in step S1907, the flow advances to step S1908 to determine whether the device of interest is included in the devices that replied to the search process executed in step S1905. If the device of interest is included, the flow advances to step S1909 to set “replied” as response status, and the flow then branches to step S1916. On the other hand, if it is determined in step S1908 that the device of interest is not included in the replied devices, the flow advances to step S1910 to acquire the response status of the device of interest in the device list. The flow advances to step S1911 to the acquired status is “replied”. If the acquired status is “replied”, the flow advances to step S1912 to set “non-replied: first time”, and the flow then skips to step S1916. If it is determined in step S1911 that the acquired status is not “replied”, the flow advances to step S1913 to update the response status “non-replied: Nth time” to “non-replied”: (N+1)th time”. The flow then advances to step S1914 to determine whether the number of times of non-replied has reached an upper limit value. If the number of times of non-replied has reached the upper limit value, the flow advances to step S1915 to delete the device of interest from the device list, and the flow advances to step S1916. If it is determined in step S1913 that the number of times of non-replied has not reached the upper limit value yet, the flow jumps to step S1916.

It is determined in step S1916 whether the current device of interest is the last device in the device list. If the device of interest is not the last device, the flow advances to step S1917 to select a device next to the current device of interest as a new device of interest, and the flow returns to step S1908 to repeat the aforementioned process. On the other hand, if it is determined in step S1916 that the device of interest is the last device, the flow jumps to step S1918 (FIG. 20A) to determine whether the devices which replied to the search process executed in step S1905, include a device which is not registered in the device list. If such device is detected, the flow advances to step S1919 to register the device in the device list, and the flow advances to step S1920. If no such device is found, the flow branches to step S1920.

In step S1920, the first device registered in the 2D layout map data is selected as a device of interest. The flow advances to step S1921 to determine whether the device of interest is registered in the device list. If the device of interest is not registered in the device list, the flow advances to step S1922 to set “not detected” as device status, and the flow then branches to step S1929. On the other hand, if the device of interest is registered in the device list in step S1921, the flow advances to step S1923 to check the response status of the device in the device list. In this case, it is determined whether the status is “replied”, and if the status is not “replied”, the flow advances to step S1924 to copy the response status of the device to a status of the device. After that, the flow jumps to step S1929.

On the other hand, if it is determined in step S1923 that the response status is “replied”, the flow advances to step S1925 to execute a process for sending an inquiry about detailed information to the device. The flow then advances to step S1926 to determine whether an answer is replied in response to the inquiry about detailed information. If no answer is replied, the flow advances to step S1927 to set “non-replied: first time” as device status, and the flow advances to step S1929; otherwise, the flow advances to step S1928 to set the acquired detailed information as device status, and the flow then advances to step S1929.

In step S1929, a device (icon) is displayed at the designated position on the displayed 2D layout map using an icon corresponding to the device status set in the above process. The flow advances to step S1930 to determine whether the current device of interest is the last device registered in the 2D layout map data. If the device of interest is the last device, this process ends; otherwise, the flow advances to step S1931 to select the next device registered in the 2D layout map data as a new device of interest. The flow then returns to step S1921 mentioned above to repeat the aforementioned process.

If it is determined in step S1906 (FIG. 19B) mentioned above that no replied device is detected, the flow advances to step S1932 to set “non-replied” as default device status. The flow advances to step S1933 to select the first device registered in the device list as a device of interest. The flow advances to step S1934 to acquire response status of the current device of interest. The flow advances to step S1935 to determine whether the acquired response status is “replied”. If the acquired value is “replied”, the flow advances to step S1936 to set “non-replied: first time” as response status, and the flow advances to step S1940. On the other hand, if it is determined in step S1935 that the response status is not “replied”, the flow advances to step S1937 to update “non-replied: Nth time” to “non-replied”: (N+1)th time”. The flow advances to step S1938 to determine whether the number of times of non-replied has reached an upper limit value. If the number of times of non-replied has reached the upper limit value, the flow advances to step S1939 to delete the device of interest from the device list, and the flow advances to step S1940. If it is determined in step S1938 that the number of times of non-replied has not reached the upper limit value yet, the flow branches to step S1940 to determine whether the current device of interest is the last device in the device list. If the device of interest is the last device, the flow jumps to step S1947 (FIG. 20A); otherwise, the flow advances to step S1941 select the next device in the device list as a new device of interest, and the flow returns to step S1934 to repeat the aforementioned process.

If it is determined in step S1903 (FIG. 19A) above that the apparatus 100 is not connected to the network, the flow advances to step S1942 to set “unknown” as default device status. The flow advances to step S1943 to select the first one of devices registered in the device list. The flow advances to step S1944 to set “unknown” as response status of the device of interest. The flow advances to step S1945 to determine whether the device of interest is the last one of devices registered in the device list. If the device of interest is the last device, the flow braches to step S1947 (FIG. 20A); otherwise, the flow advances to step S1946 to select the next device in the device list as a new device of interest, and the flow returns to step S1944 to repeat the aforementioned process.

In step S1947 (FIG. 20A), the first one of devices registered in the 2D layout map data is selected as a device of interest. The flow advances to step S1948 to display an icon corresponding to the default device status at the designated position of the device of interest on the 2D layout map. The flow advances to step S1949 to determine whether the current device of interest is the last one of devices registered in the 2D layout map data. If the device of interest is not the last device, the flow advances to step S1950 to select the next device registered in the 2D layout map data as a new device of interest, and the flow returns to step S1948 to repeat the aforementioned process. If it is determined in step S1949 that the device of interest is the last device, this process ends.

Note that the process according to the ninth embodiment may be executed upon displaying a 2D layout map or may be executed in synchronism with an external event such as a timer event or the like so as to re-draw the display contents of the 2D layout map.

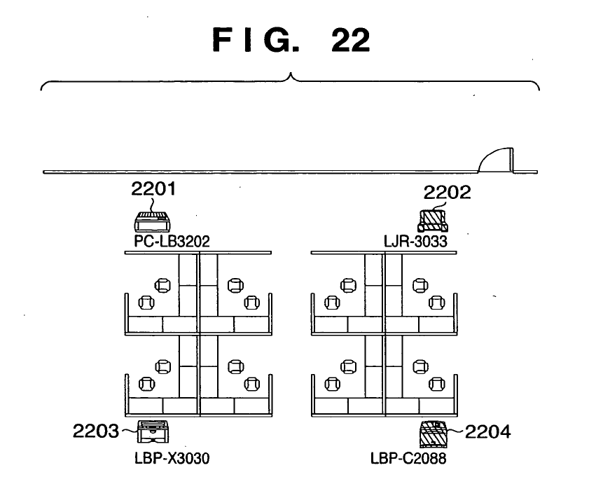

FIG. 22 shows an example of a window of a 2D layout map displayed in the ninth embodiment.

Referring to FIG. 22, reference numerals 2201, 2202, 2203, and 2204 denote device icons corresponding to devices registered in 2D layout map data, which is used to display the 2D layout map.

In this window, the device icons 2201 and 2203 indicate the locations of devices which replied to the device search process or the inquiry about detailed information. On the other hand, the device icons 2202 and 2204 indicate the locations of non-replied devices, and are grayed out.

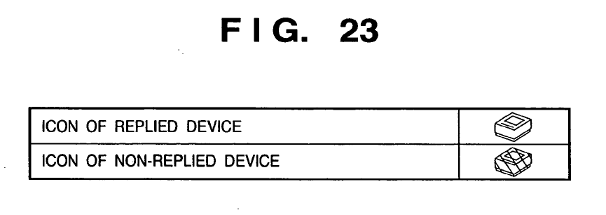

FIG. 23 shows an example of icons according to the ninth embodiment.

The first row shows an icon corresponding to a replied device, and the second row shows an icon corresponding to a non-replied device.

As described above, according to the ninth embodiment, since an icon having a display pattern corresponding to the status of the device is displayed, even for a non-replied device, the device administrator can easily recognize replied and non-replied devices, and can recognize the physical locations of a device even if the device is a non-replied device.

### 10th Embodiment

The 10th embodiment of the present invention will be described below. The arrangement of the apparatus 100 of the 10th embodiment is the same as that shown in FIG. 1 described in the aforementioned first embodiment. Also, the flowcharts that show the basic operation are the same as those shown in FIGS. 19A to 19C and FIGS. 20A and 20B. The 2D layout map data used in the 10th embodiment has the same structure as that shown in FIG. 4, and the 2D layout map to be displayed in the 10th embodiment has the same layer structure as that shown in FIG. 5. Furthermore, the data of the device list used in the 10th embodiment has the same data structure as that shown in FIG. 21, and the 2D layout map adopts the same display pattern as that shown in FIG. 22.

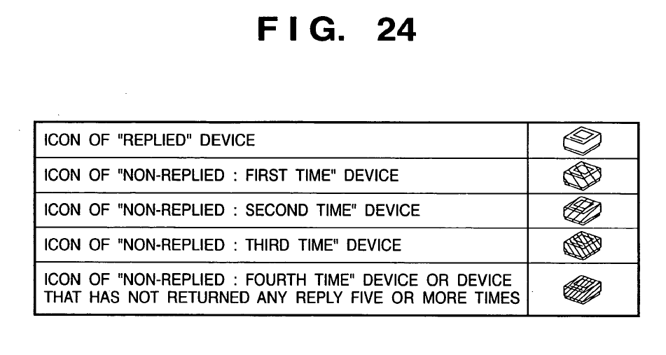

FIG. 24 depicts a view for explaining display patterns of device icons according to the 10th embodiment of the present invention.

Referring to FIG. 24, the first row shows an icon of a replied device. This image is an example of an icon which expresses a basic device, and it is preferable to assign other icon to devices of different types and to prepare various color icons to express various states of devices. The second row shows an icon corresponding to a device “non-replied: first time”. This icon is colored slightly darker than the device icon of the replied device shown in the first row. The third row shows an icon corresponding to a device “non-replied: second time”. This icon is colored slightly darker than the icon of the device “non-replied: first time in the second row. The fourth row shows an icon corresponding to a device “non-replied: third time”. The fifth row shows an icon corresponding to a device “non-replied: fourth time” and a device which does not respond five or more times.

In the 10th embodiment, the upper limit value of the number of times of non-replied is set to be “5”, and a device which never successively replied five times is deleted from the device list. Therefore, a device which did not reply five or more times is displayed using the icon until a communication with the device is recovered.

Note that the icons in the second and subsequent rows are used for a device that uses the icon in the first row as the basic display pattern. For a device that uses another basic display pattern, icons prepared by applying a process for gradually darkening an icon of the basic display pattern are used.

As described above, according to the 10th embodiment, a non-replied device can be displayed in a pattern which allows the user to visually understand an elapsed time since the last response with reference to the number of times of search conducted during the time. In this manner, the user can recognize the detailed state of devices which can communicate, and the current states of even non-replied devices.

### 11th Embodiment

The 11th embodiment of the present invention will be described below. The arrangement of the information processing apparatus according to the 11th embodiment is the same as that shown in FIG. 1 explained in the aforementioned first embodiment. The basic operation of the 11th embodiment is the same as the process shown in FIGS. 19A to 19C and FIGS. 20A and 20B. Also, the 2D layout map data, its structure, and the 2D layout map used in the 11th embodiment adopt the same configurations as those in the above embodiments. In the 11th embodiment, icons indicating responding and non-replied icons adopt the same display patterns as those shown in FIG. 23.

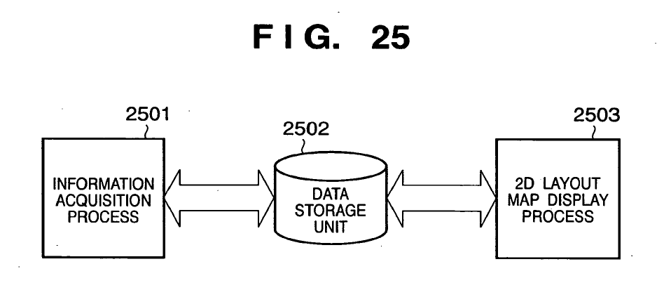

FIG. 25 depicts a diagram showing the arrangement of principal software modules according to the 11th embodiment of the present invention.

Reference numeral 2501 denotes an information acquisition process, which directly communicates with a device to acquire information associated with the current status of the device, and to store the information in a data storage unit 2502. The data storage unit 2502 stores data acquired by the information acquisition process 2501, and the information acquisition process 2501 and a 2D layout map display process 2503 can read out the stored data. The 2D layout map display process 2503 reads out data stored in the data storage unit 2502, and displays a 2D layout map on the display device 107 on the basis of the readout data.

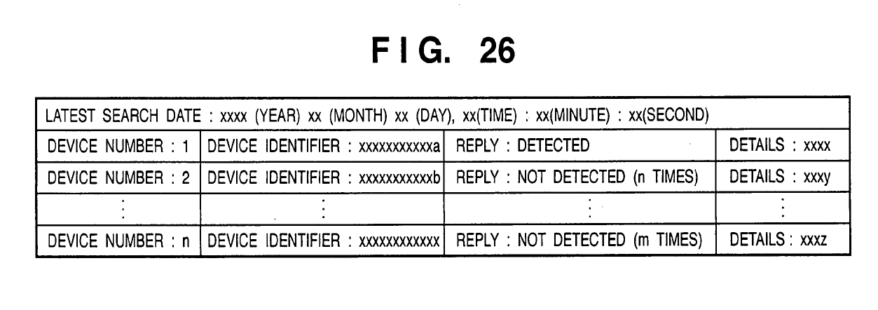

Device list data used in the 11th embodiment is a list stored in the secondary storage device 106, and has a data structure, as shown in FIG. 26.

The first row stores “last search execution date”, in which the latest date upon conducting a device search is written. The second and subsequent rows store a list of devices indicating “replied, non-replied” as previous search results. Respective devices are assigned serial device numbers, and the list stores information such as device identifiers used to identify respective devices, replied status, detailed statuss, and the like.

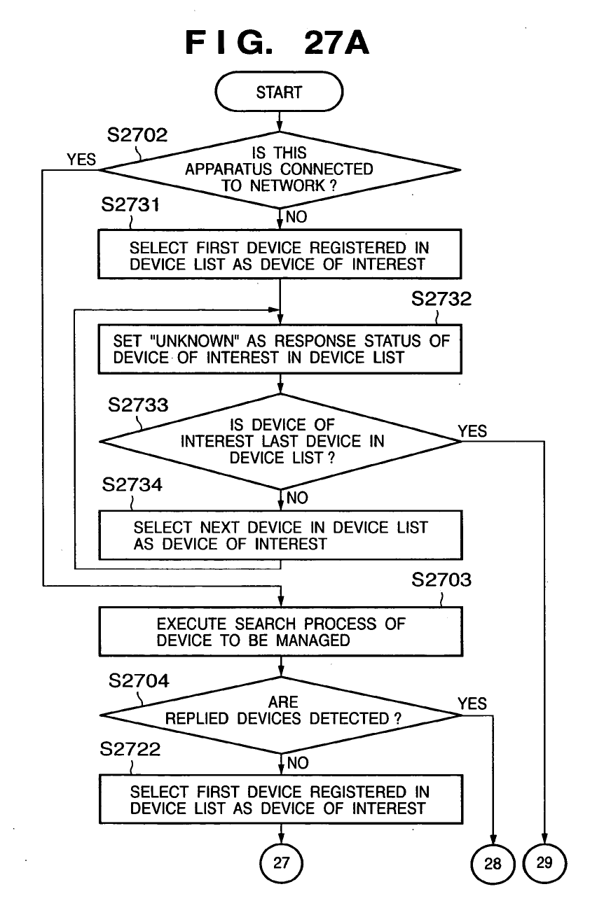

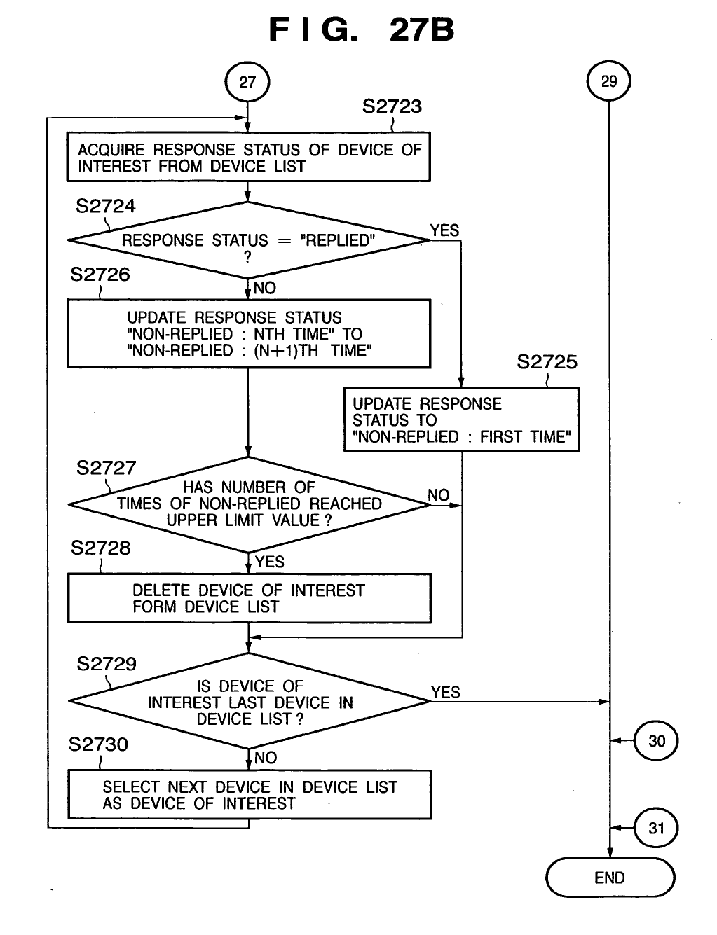

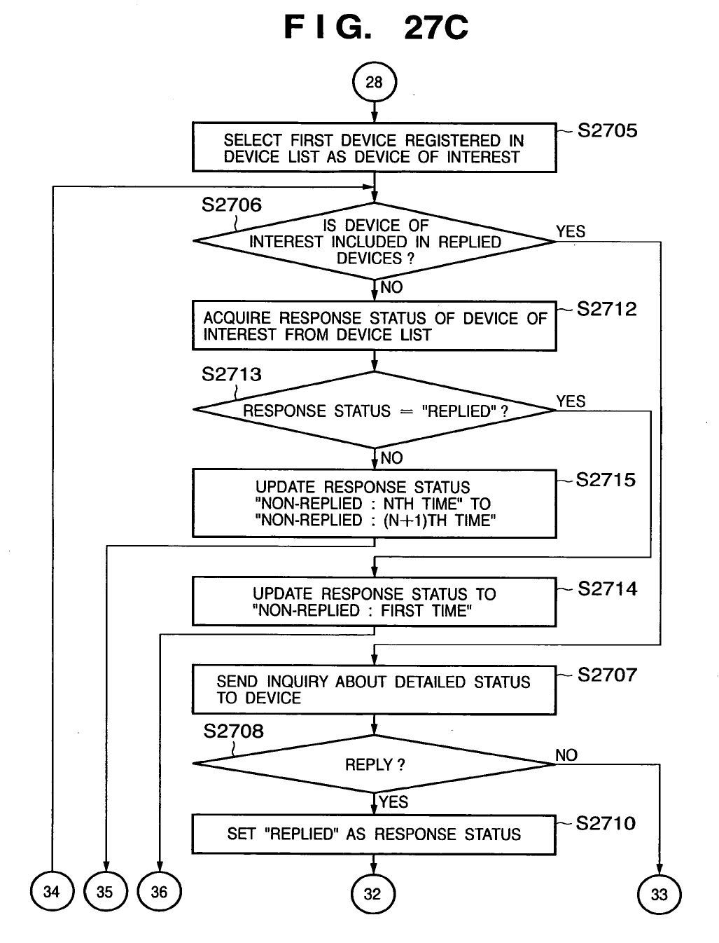

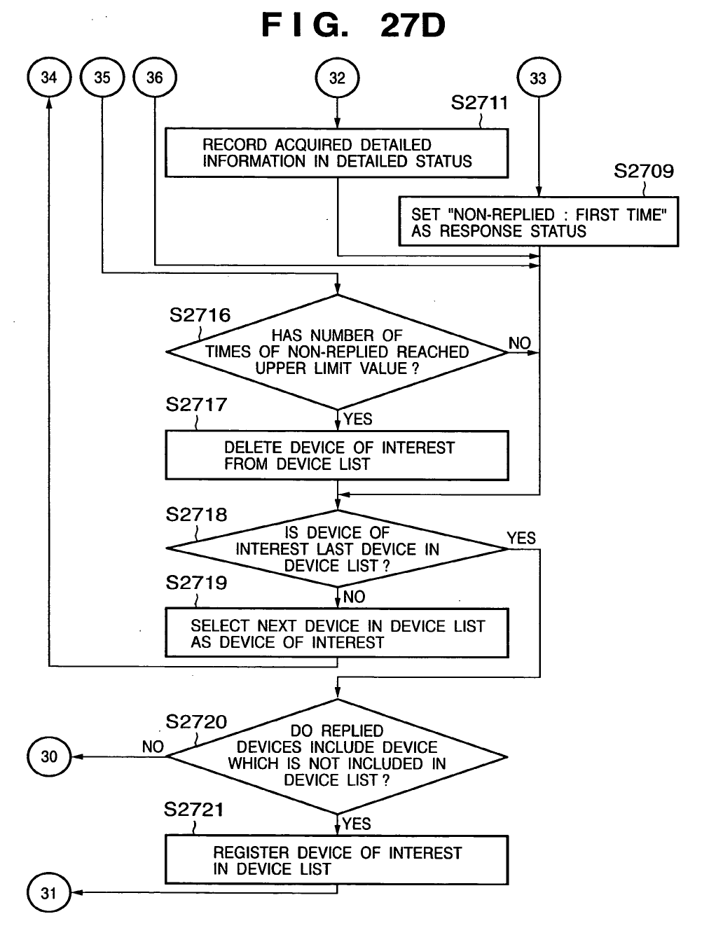

FIGS. 27A to 27D are flowcharts for explaining the basic operation of the information acquisition process 2501 according to the 11th embodiment of the present invention. The basic operation of the information acquisition process 2501 according to the 11th embodiment will be explained below with reference to these flowcharts.

It is determined in step S2702 whether the information processing apparatus 100 is connected to the network 112. If the apparatus is connected to the network, the flow jumps to step S2703; otherwise, the flow advances to step S2731. In step S2703, a search process of devices to be managed is executed. The flow advances to step S2704 to determine whether replied devices exist. If replied devices exist, the flow branches to step S2705; otherwise, the flow advances to step 2722.

In step S2705, the first device registered in the device list stored in the data storage unit 2502 is selected as a device of interest. The flow advances to step S2706 to determine whether the device of interest is included in the replied devices. If the device of interest is included in the replied devices, the flow braches to step S2707; otherwise, the flow advances to step S2712.

In step S2707, an inquiry about detailed status is sent to the device of interest. The flow advances to step S2708 to determine whether an answer is replied. If no answer is replied, the flow jumps to step S2709 to set “non-replied: first time” as response status, and the flow jumps to step S2718. If an answer is returned in step S2708, the flow advances to step S2710 to set “replied” as response status. The flow then advances to step S2711 to store the acquired detailed status in the detailed status field of the device list, and the flow jumps to step S2718.

On the other hand, if it is determined in step S2706 that the device of interest is not included in the replied devices, the flow advances to step S2712 to acquire the response status of the device of interest registered in the device list. The flow advances to step S2713 to determine whether the registered status is “replied”. If the registered status is “replied”, the flow jumps to step S2714 to set “non-replied: first time”, and the flow jumps to step S2718. On the other hand, if it is determined in step S2713 that the registered status is not “replied”, the flow advances to step S2715 to update response status “non-replied: Nth time” to “non-replied: (N+1)th time”. The flow then advances to step S2716 to determine whether the number of times of non-replied has reached an upper limit value. If the number of times of non-replied has reached the upper limit value, the flow advances to step S2717 to delete the device of interest from the device list, and the flow jumps to step S2718. If it is determined in step S2716 that the number of times of non-replied has not reached the upper limit value yet, the flow jumps to step S2718.

It is determined in step S2718 whether the current device of interest is the last device in the device list. If the device of interest is not the last device, the flow advances to step S2719 to select the next device in the device list as a new device of interest, and the flow returns to step S2706 to repeat the aforementioned process. On the other hand, if it is determined in step S2718 that the device of interest is the last device, the flow jumps to step S2720 to determine whether the replied devices include a device which is not registered in the device list. If such device is detected, the flow advances to step S2721 to register the device, which was not included in the device list, thus ending the process. If no such device is found in step S2720, the process ends.

If it is determined in step S2704 that no replied device is detected, the flow advances to step S2722 to select the first device registered in the device list as a device of interest. The flow advances to step S2723 to acquire the response status of the device of interest from the device list. The flow advances to step S2724 to determine whether the response status is “replied”. If the response status is “replied”, the flow jumps to step S2725 to update the response status to “non-replied: first time”, and the flow branches to step S2729. On the other hand, if it is determined in step S2724 that the response status is not “replied”, the flow advances to step S2726 to update the response status “non-replied: Nth time” to “non-replied: (N+1)th time”. The flow advances to step S2727 to determine whether the number of times of non-replied has reached an upper limit value. If the number of times of non-replied has reached the upper limit value, the flow advances to step S2728 to delete the device of interest from the device list, and the flow advances to step S2729. If the number of times of non-replied has not reached the upper limit value yet, the flow jumps to step S2729 to determine whether the current device of interest is the last device in the device list. If the device of interest is not the last device, the flow advances to step S2730 to select the next device in the device list as a new device of interest, and the flow returns to step S2723 to repeat the aforementioned process. On the other hand, if it is determined in step S2729 that the device of interest is the last device, this process ends.

Furthermore, if it is determined in step S2702 that the apparatus 100 is not connected to the network 112, the flow advances to step S2731 to select the first device registered in the device list as a device of interest. The flow advances to step S2732 to set detailed status “unknown” for the device of interest in the device list. The flow advances to step S2733 to determine whether the device of interest is the last device registered in the device list. If the device of interest is not the last device, the flow advances to step S2734 to select the next device registered in the device list as a new device of interest, and the flow returns to step S2732 to repeat the aforementioned process. If it is determined in step S2733 that the device of interest is the last device, this process ends.

Note that this process is repetitively launched as needed in response to a timer event and the like, and the contents of the device list stored in the data storage unit 2502 are updated every time this process is launched.

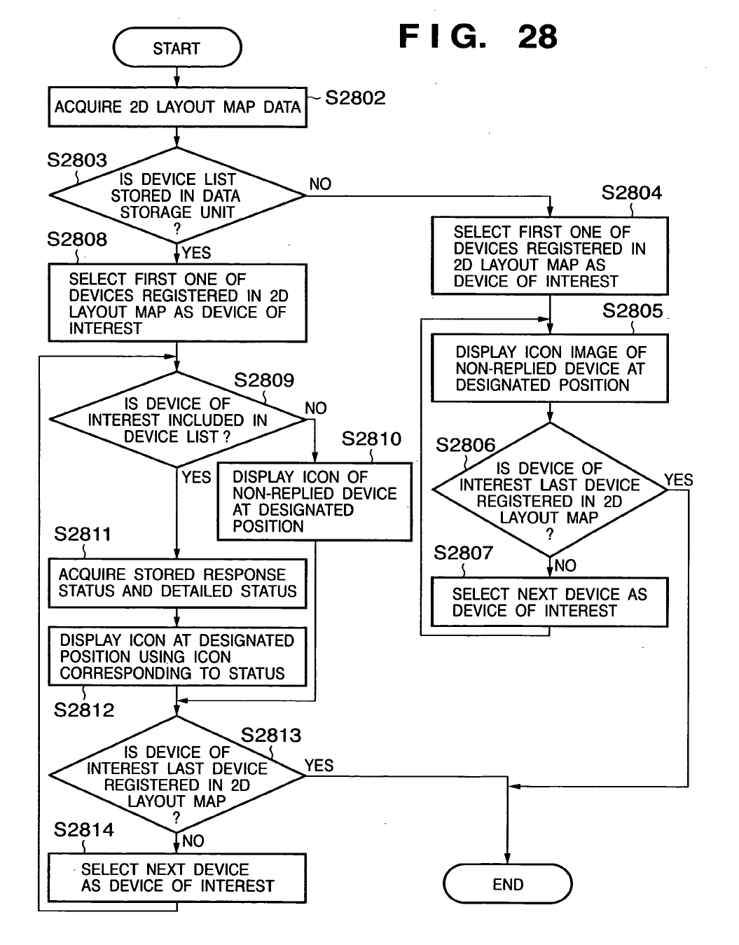

FIG. 28 is a flowchart showing the basic operation of the 2D layout map display process 2503 according to the 11th embodiment. The basic operation of the 2D layout map display process 2503 according to the 11th embodiment will be described below with reference to this flowchart.

In step S2802, 2D layout map data is acquired. The flow advances to step S2803 to determine whether the device list is stored in the data storage unit 2502. If no device list is stored, the flow advances to step S2804; otherwise, the flow advances to step S2808. In step S2804, the first one of devices registered in the 2D layout map data is selected as a device of interest. The flow advances to step S2805 to display an icon corresponding to a non-replied device at a position corresponding to the current device of interest. The flow advances to step S2806 to determine whether the current device of interest is the last device registered in the 2D layout map data. If the device of interest is not the last device, the flow advances to step S2087 to select the next device registered in the 2D layout map data as a new device of interest. The flow then returns to step S2805 to repeat the aforementioned process. If it is determined in step S2806 that the device of interest is the last device, this process ends.

If it is determined in step S2803 that the device list is stored, the flow advances to step S2808 to select the first one of devices registered in the 2D layout map data as a device of interest. The flow advances to step S2809 to determine whether the device of interest is registered in the device list. If the device of interest is not registered, the flow advances to step S2810 to display an icon corresponding to a non-replied device at the corresponding position. The flow then advances to step S2813.

On the other hand, if it is determined in step S2809 that the device of interest is registered in the device list, the flow advances to step S2811 to acquire the stored response status and detailed status from the device list. The flow advances to step S2812 to display an icon corresponding to that response status at the corresponding position. The flow advances to step S2813 to determine whether the current device of interest is the last device registered in the 2D layout map data. If the device of interest is not the last device, the flow advances to step S2814 to select the next device registered in the 2D layout map data as a new device of interest, and the flow returns to step S2809 to repeat the aforementioned process. If it is determined in step S2813 that the device of interest is the last device, the process ends.

The process according to the 11th embodiment may be executed only once upon displaying the 2D layout map for the first time or may be executed upon displaying the 2D layout map again after an elapse of a predetermined period of time.

As described above, according to the 11th embodiment, since even a non-replied device is displayed using an icon with the corresponding display pattern, the device administrator can easily recognize replied and non-replied devices, as in the ninth embodiment. As for non-replied devices, the administrator can recognize their physical locations.

Furthermore, according to the 11th embodiment, since the process for acquiring detailed information of a device and the process for displaying the 2D layout map are separated, the time or the like required to confirm if a non-replied device exists can be suppressed from influencing the display of the 2D layout map, and the device data update efficiency can be greatly improved.

As described above, according to the ninth to 11th embodiments, the user can easily intuitively identify the actual locations of devices managed via the network. Even when a device group is set on the window displaying the 2D layout map, the device locations can be presented without introducing confusion about devices which are laid out actually. In this manner, more efficient, user-friendly device management can be implemented.

### 12th Embodiment

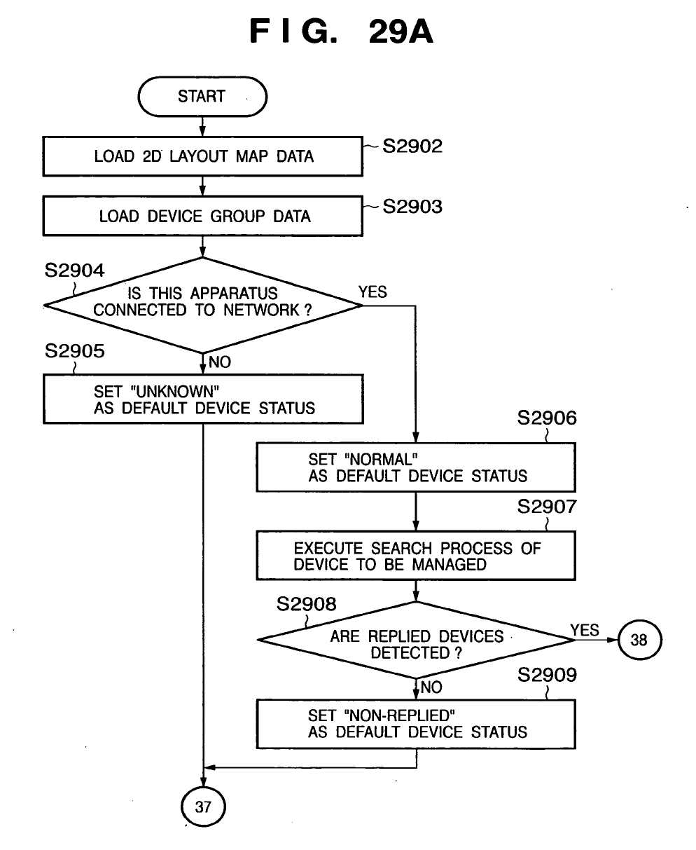

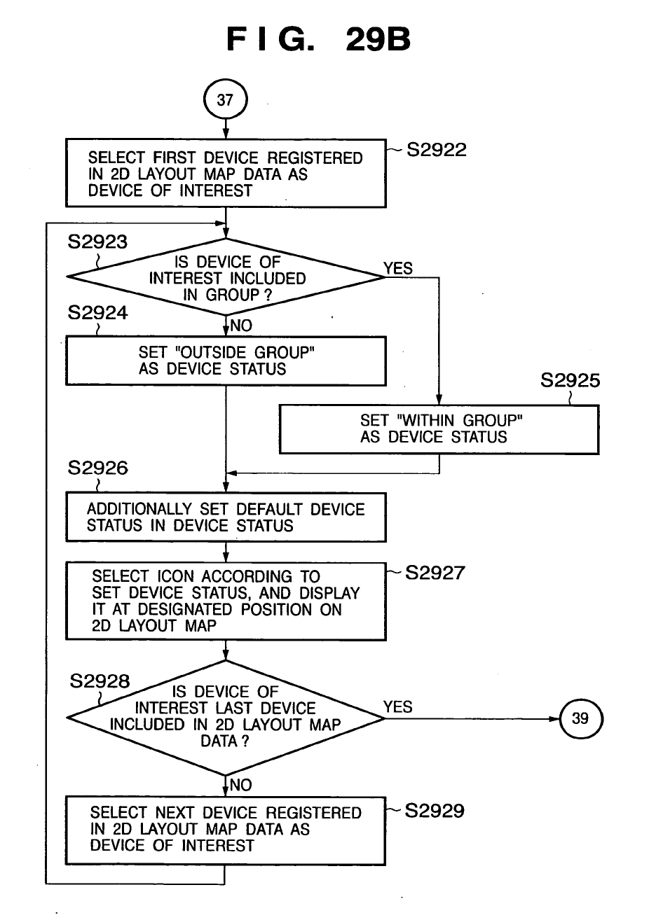

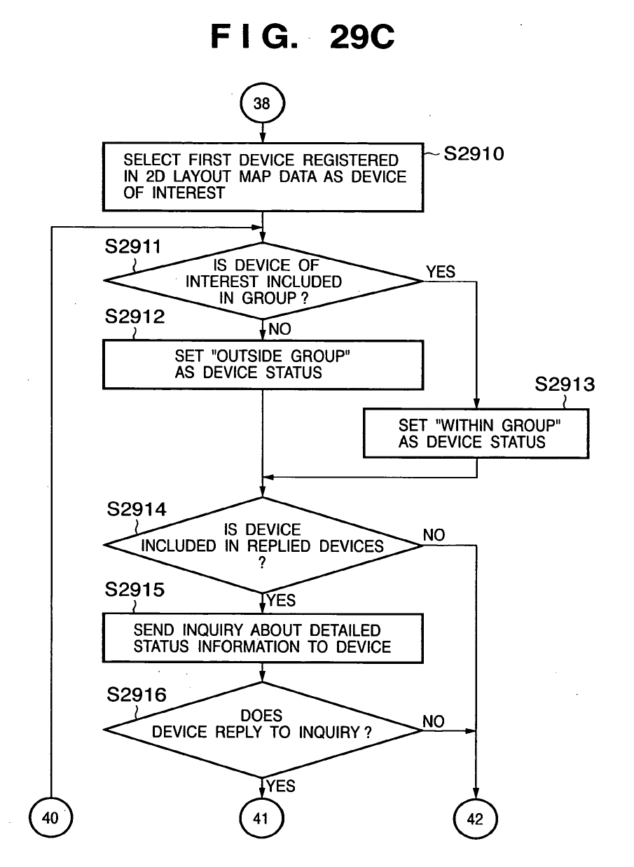

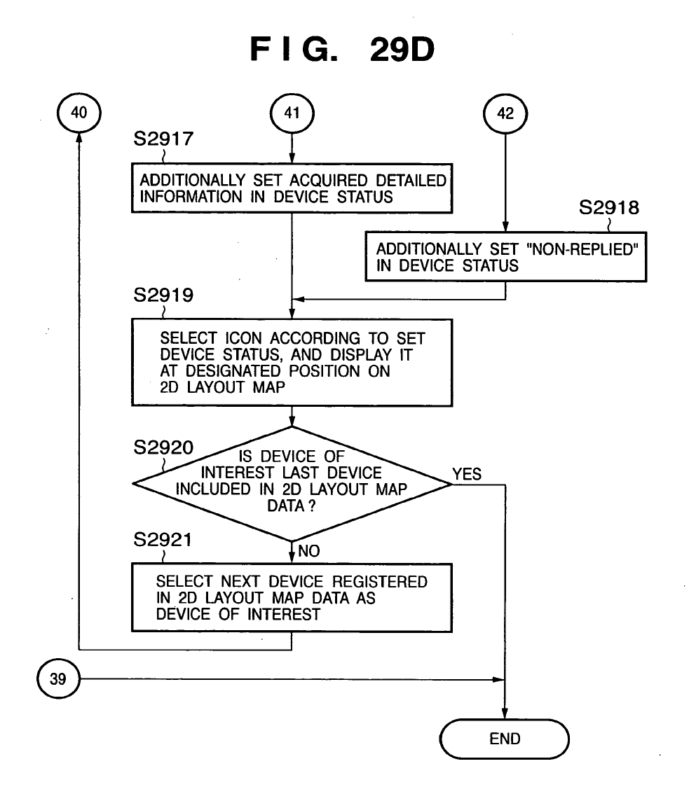

FIGS. 29A to 29D are flowcharts showing the control operation of the information processing apparatus 100 according to the 12th embodiment of the present invention. A program that implements this process is stored in the ROM 103 or secondary storage device 106, and is executed under the control of the CPU 101. Note that the hardware arrangement of the information processing apparatus 100 and layout map data in the 12th embodiment are the same as those in the first embodiment, and a description thereof will be omitted.

When this process starts, 2D layout map data to be displayed, which is stored in the secondary storage device 106, is acquired in step S2902. The 2D layout map data lists up information associated with a 2D layout map such as a map name and the like, information of a background to be displayed on the map, and information of devices to be laid out. An example of the 2D layout map data is as has been explained previously with reference to FIG. 4, and the logical structure of that 2D layout map is the same as that explained with reference to FIG. 5 above.

After the 2D layout map data is acquired in step S2902, the flow advances to step S2903 to acquire data of a device group stored in the secondary storage device 106. Note that the data of the device group lists devices which belong to a given group with a specific group name, and it is determined that devices listed in this group belong to the device group with the specific group name.

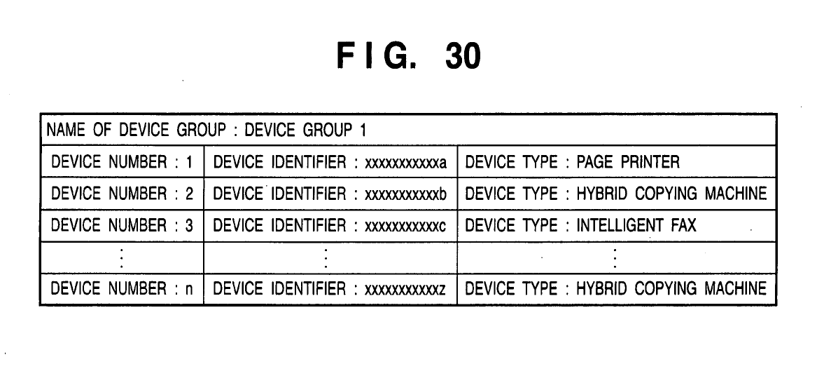

FIG. 30 shows an example of the data of the device group according to the 12th embodiment.

In FIG. 30, a device identifier uses a MAC address or the like as a globally unique identifier which is assigned to the network interface 111. Alternatively, another identifiable information may be used depending on application fields. In this case, only a device identifier and device type are presented as information of a device which belongs to a device group. However, a format that stores various kinds of information used to describe device features may be used.

The flow advances to step S2904 to determine whether the apparatus 100 is connected to the network 112. If the apparatus is not connected, the flow advances to step S2905 to set “unknown” as default device status, and the flow advances to step S2922. On the other hand, if it is determined in step S2904 that the apparatus 100 is connected to the network, the flow advances to step S2906 set “normal” as default device status. The flow advances to step S2907 to execute a device search process. This device search process is normally executed via network communications in which devices to be managed return responses, and mainly uses broadcasting of a packet of a specific protocol or trying to make a 1-to-1 communication with devices with previous management records.

The flow advances to step S2908 to determine whether devices which replies to the search process executed in step S2907 are detected. If no replied device is detected, the flow advances to step S2909 to set “non-replied” as default device status, and the flow advances to step S2922. If it is determined in step S2908 that replied devices are detected, the flow advances to step S2910 to select the first one of devices which are registered and listed in the 2D layout map data acquired in step S2902 as a device of interest. It is determined in step S2911 whether the device of interest belongs to the designated device group. If the device of interest does not belong to the device group, the flow advances to step S2912 to set “outside designated group” as device status, and the flow advances to step S2914. On the other hand, if the device of interest belongs to the designated device group, the flow advances to step S2913 to set “within designated group” as device status, and the flow advances to step S2914.

It is determined in step S2914 whether the devices replied to the search process which is executed in step S2907 include the current device of interest. If the replied devices include the current device of interest, the flow advances to step S2915 to execute a process for sending an inquiry about detailed status to the current device of interest. The flow advances to step S2916 to determine whether the current device of interest answers to the inquiry. If the answer is normally returned, the flow advances to step S2917 to additionally set the detailed status acquired in step S2915 to the device status of the current device of interest, and the flow advances to step S2919. If status “normal” is additionally set for a device whose status was “outside designated group”, status “outside designated group: normal” is set for the device as a whole. The same applies to the following description.

If it is determined in step S2914 above that the device of interest does not reply, or if it is determined in step S2916 that the device of interest does not return any answer to the inquiry about detailed status, the flow advances to step S2918 to additionally set “non-replied” as device status. The flow then advances to step S2919.

In step S2919, an icon corresponding to the device status is retrieved, and is displayed on the 2D layout map as an icon corresponding to the device of interest. That is, in this case, an icon indicating each device is displayed as that which depends on whether or not the device belongs to a given group and whether or not the device returns a reply. The flow advances to step S2920 to determine whether the current device of interest is the last one of devices registered in the 2D layout map data to be displayed. If the device of interest is not the last device, the flow advances to step S2921 to select a device next to the current device of interest of those registered in the 2D layout map data as a new device of interest, and the flow returns to step S2911 to repeat the aforementioned process. If it is determined in step S2920 that the device of interest is the last device, this process ends.

After “unknown” is set as default device status in step S2905, or after “non-replied” is set as default status in step S2909, the flow advances to step S2922 to select the first one of devices registered in the 2D layout map data. The flow advances to step S2923 to determine whether the current device of interest is included in the group. If the device of interest is not included in the group, the flow advances to step S2924 to set “outside designated group” as device status, and the flow advances to step S2926. On the other hand, if the device of interest is included in the group, the flow advances to step S2925 to set “within designated group” as device status, and the flow advances to step S2926.

In step S2926, the default device status set previously is additionally set to the device status. The flow advances to step S2927 to retrieve an icon corresponding to the device status, and to display it on the 2D layout map as an icon corresponding to the device of interest. The flow advances to step S2928 to determine whether the current device of interest is the last one of devices registered in the 2D layout map data to be displayed. If the device of interest is not the last device, the flow advances to step S2929 to select a device next to the current device of interest of those registered in the 2D layout map data as a new device of interest, and the flow returns to step S2923 to repeat the aforementioned process. On the other hand, if it is determined in step S2928 that the device of interest is the last device, this process ends.

An example of the 2D layout map window of devices to be displayed by the information processing apparatus 100 according to the present invention is basically the same as that shown in FIG. 22. More specifically, icons 2201 and 2203 indicate devices which are registered in the currently designated device group, and icons 2202 and 2204 indicate device which are not included in that group. For this reason, the device icons 2201 and 2203 are displayed using each icon indicating status of a device which belongs to a group. On the other hand, devices corresponding to the icons 2202 and 2204 are respectively displayed using icons of a device which does not belong to any group.

In the 12th embodiment, the icon of a device which does not belong to any group is displayed about 50% darker than that of a device which belongs to the group.

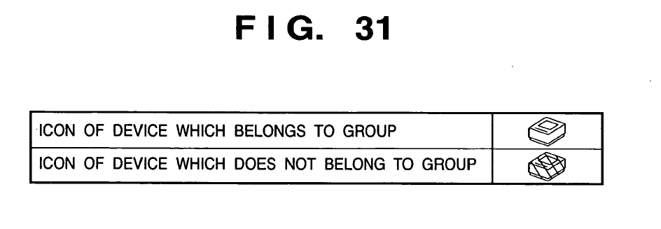

FIG. 31 depicts a view for explaining a comparison example of the display states of icons according to the 12th embodiment of the present invention.

Referring to FIG. 31, the first row shows an icon corresponding to a device which belongs to a group, and this icon is displayed in bright color. The second row shows an icon which does not belong to any group, and this icon is displayed in color darker than the icon in the first row.

As described above, according to the 12th embodiment, detailed information about device status is acquired, if possible, for a device which belongs to the designated device group, and the operation state of the device is displayed using an icon on the 2D layout map. As for a device which does not belong to any device group, acquisition of its detailed information is skipped. Also, the icon of a device which belongs to a group, and that of a device which does not belong to any group can be displayed using easily identifiable patterns.

In this manner, devices which belong to the designated device group can be easily determined, and since icons corresponding to devices are displayed at the corresponding positions, correspondence between the icons and actually laid-out devices can be easily understood.

### 13th Embodiment

The 13th embodiment of the present invention will be described below. The arrangement of the information processing apparatus 100 (management apparatus) of the 13th embodiment is the same as that which has been explained in the above embodiments. Also, the 2D layout map data, 2D layout map, device group data, and displayed 2D layout map are the same as those in the above embodiments, and the device icons to be displayed, which indicate devices within and outside the group have the same patterns as those shown in FIG. 31.

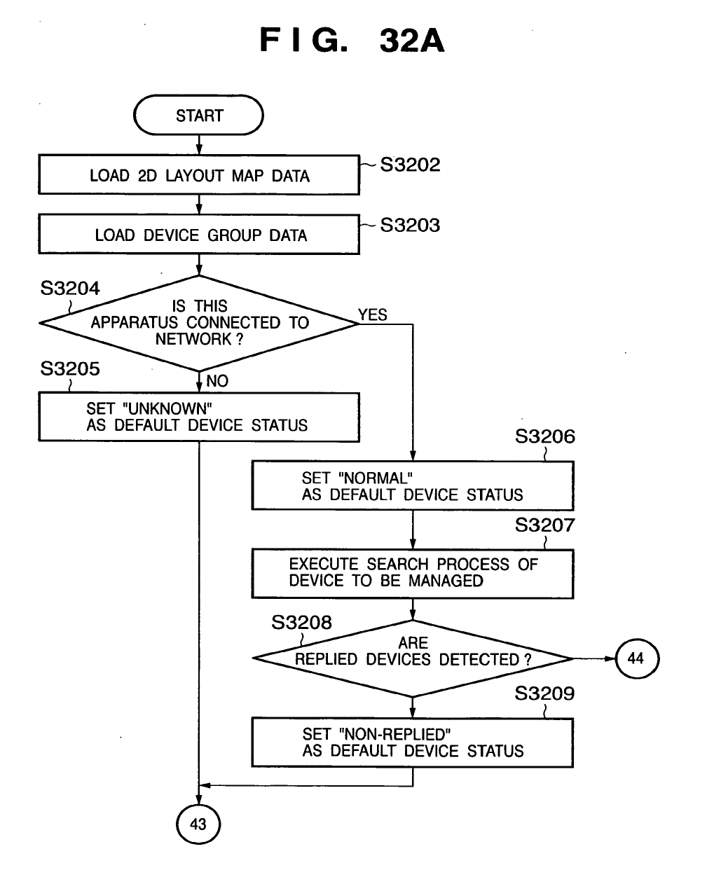

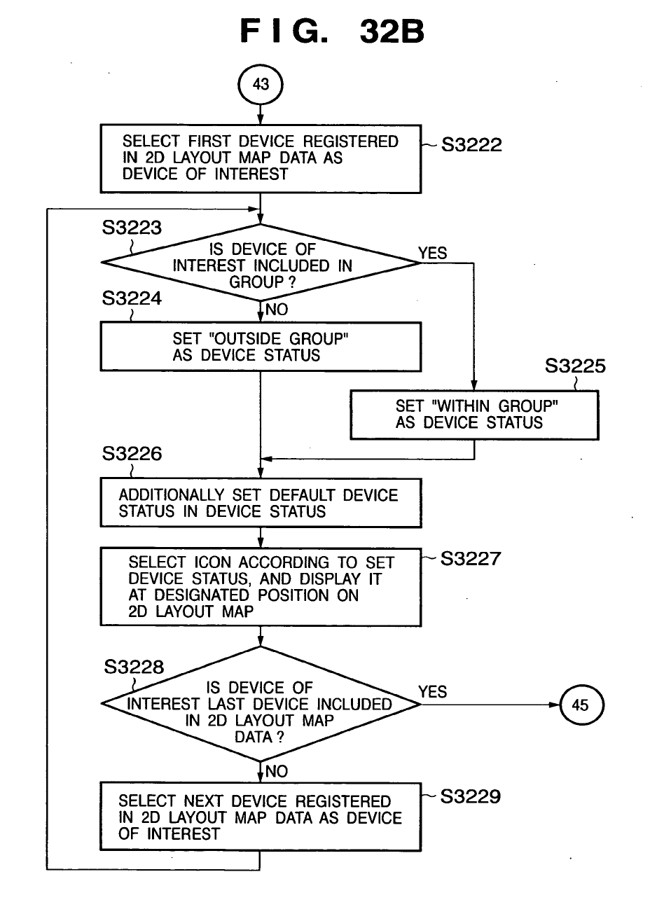

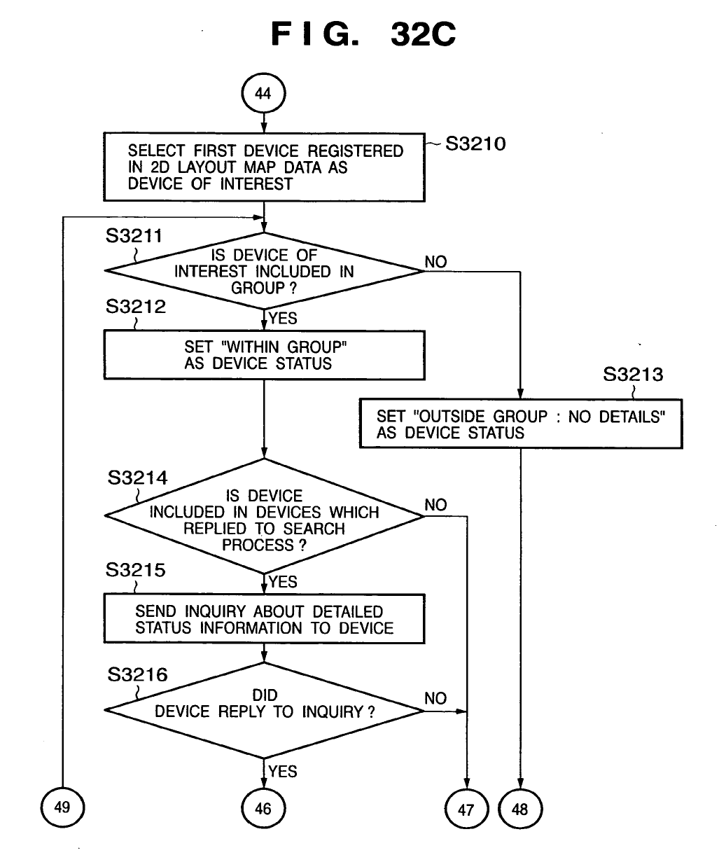

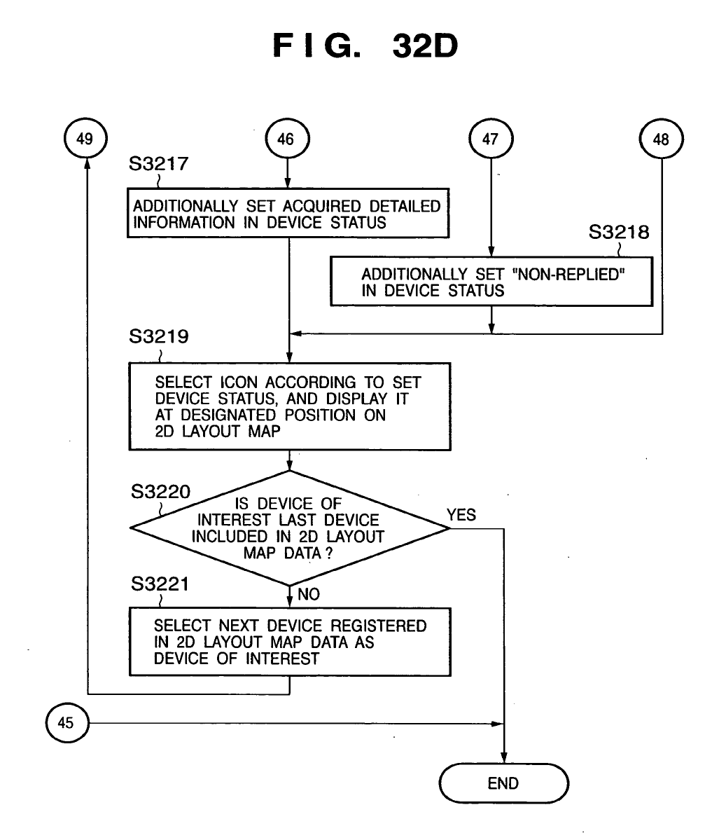

FIGS. 32A to 32D are flowcharts for explaining the basic operation of the information processing apparatus 100 according to the 13th embodiment of the present invention. A program that implements this process is stored in the ROM 103 or secondary storage device 106, and is executed under the control of the CPU 101.

Two-dimensional layout map data to be displayed, which is stored in the secondary storage device 106, is acquired in step S3202. The flow advances to step S3203 to acquire device group data stored in the secondary storage device 106. The flow advances to step S3204 to determine whether the apparatus 100 is connected to the network 112. If the apparatus is not connected, the flow advances to step S3205 to set “unknown” as default device status, and the flow advances to step S3222. On the other hand, if the apparatus is connected, the flow advances to step S3206 set “normal” as default device status. The flow advances to step S3207 to execute a device search process. This device search process is normally executed via network communications in which devices to be managed reply, and mainly uses broadcasting of a packet of a specific protocol or trying to make a 1-to-1 communication with devices with previous management records. The flow advances to step S3208 to determine whether replied devices to the search process executed in step S3207 are detected. If no replied device is detected, the flow advances to step S3209 to set “non-replied” as default device status, and the flow advances to step S3222.

If it is determined in step S3208 that replied devices are detected, the flow advances to step S3210 to select the first one of devices which are registered and listed in the 2D layout map data acquired in step S3202 as a device of interest. The flow advances to step S3211 to determine whether the device of interest belongs to the designated device group. If the device of interest belongs to the device group, the flow advances to step S3212 to set “within designated group” as device status, and the flow advances to step S3214. On the other hand, if the device of interest does not belong to the designated device group, the flow advances to step S3213 to set “outside designated group: no details” as device status, and the flow jumps to step S3219.

It is determined in step S3214 whether the replied devices to the search process of devices to be managed, which is executed in step S3207, include the current device of interest. If the replied devices include the device of interest, the flow advances to step S3215; otherwise, the flow jumps to step S3218. In step S3215, a process for sending an inquiry about detailed status to the current device of interest is executed. The flow advances to step S3216 to determine whether a reply is normally returned. If a reply is normally returned, the flow advances to step S3217; otherwise, the flow advances to step S3218. In step S3217, the detailed status acquired in step S3215 is additionally set to the device status, and the flow advances to step S3219. If status “normal” is additionally set for a device having status “outside designated group”, status “outside designated group: normal” is set for the device as a whole. The same applies to the following description.

If it is determined in step S3214 above that the device of interest never reply, or if it is determined in step S3216 that the device of interest does not reply to the inquiry about detailed status, the flow jumps to step S3218 to additionally set “non-replied” as device status. The flow then advances to step S3219. Also, after status “outside group: no details” is designated for the device outside the group in step S3213 above or after the detailed status acquired from the device is set to device status in step S3217, the flow advances to step S3219 to retrieve an icon corresponding to the device status, and to display it on the 2D layout map as an icon corresponding to the device of interest. The flow then advances to step S3220. It is determined in step S3220 whether the current device of interest is the last one of devices registered in the 2D layout map data to be displayed. If the device of interest is not the last device, the flow advances to step S3221 to select a device next to the current device of interest of those registered in the 2D layout map data as a new device of interest, and the flow returns to step S3211 to repeat the aforementioned process. If the device of interest is the last device, this process ends.

After “unknown” is set as default device status in step S3205, or after “non-replied” is set as default status in step S3209, the flow advances to step S3222 to select the first one of devices registered in the 2D layout map data. The flow advances to step S3223 to determine whether the current device of interest is included in the group. If the device of interest is not included in the group, the flow advances to step S3224 to set “outside designated group” as device status, and the flow advances to step S3226. On the other hand, if the device of interest is included in the group, the flow advances to step S3225 to set “within designated group” as device status, and the flow advances to step S3226.

In step S3226, the default device status set previously is additionally set to the device status. The flow advances to step S3227 to retrieve an icon corresponding to the device status, and to display it on the 2D layout map as an icon corresponding to the device of interest. The flow advances to step S3228 to determine whether the current device of interest is the last one of devices registered in the 2D layout map data to be displayed. If the device of interest is not the last device, the flow advances to step S3229 to select a device next to the current device of interest of those registered in the 2D layout map data as a new device of interest, and the flow returns to step S3223 to repeat the aforementioned process. On the other hand, if it is determined in step S3228 that the device of interest is the last device, this process ends.

As described above, according to the 13th embodiment, in addition to the effects of the aforementioned 12th embodiment, since an inquiry about detailed information to a device which does not belong to the device group can be avoided, the time required to acquire detailed information of a device can be shortened, thus improving efficiency about management of devices which belong to the designated device group.

### 14th Embodiment

The 14th embodiment of the present invention will be described below. The arrangement of the management apparatus (information processing apparatus) 100 according to the 14th embodiment is the same as that shown in FIG. 1 described in the above embodiment. The 2D layout map data, 2D layout map, device group data configuration, and display of device icons adopt the same formats as those in the above embodiments.

The principal software module configuration according to the 14th embodiment is as shown in FIG. 25 above.

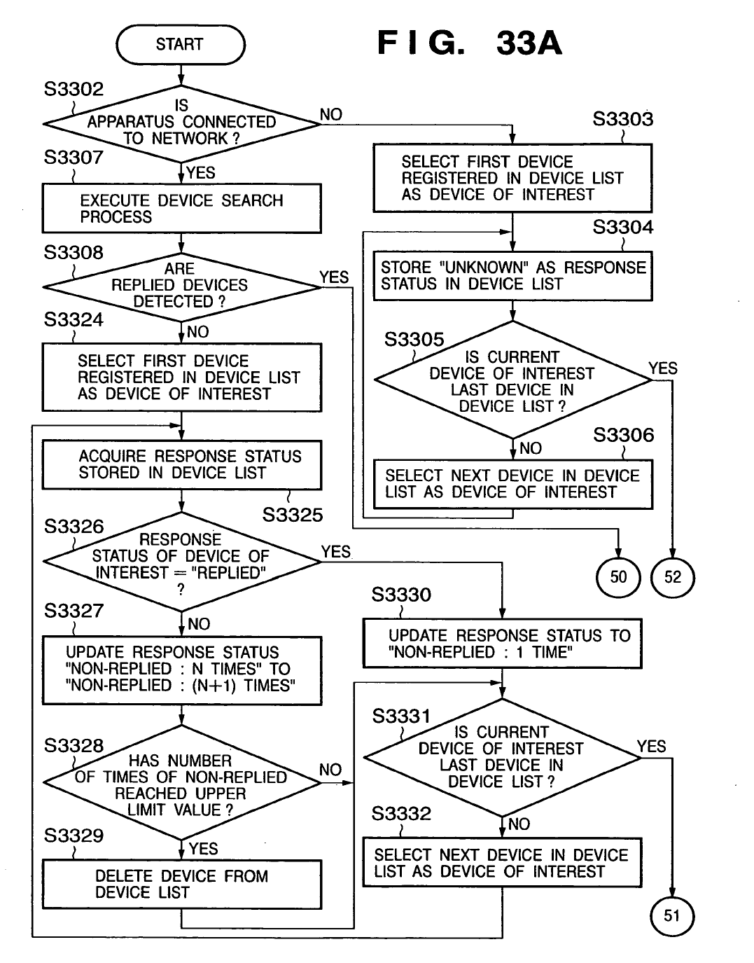

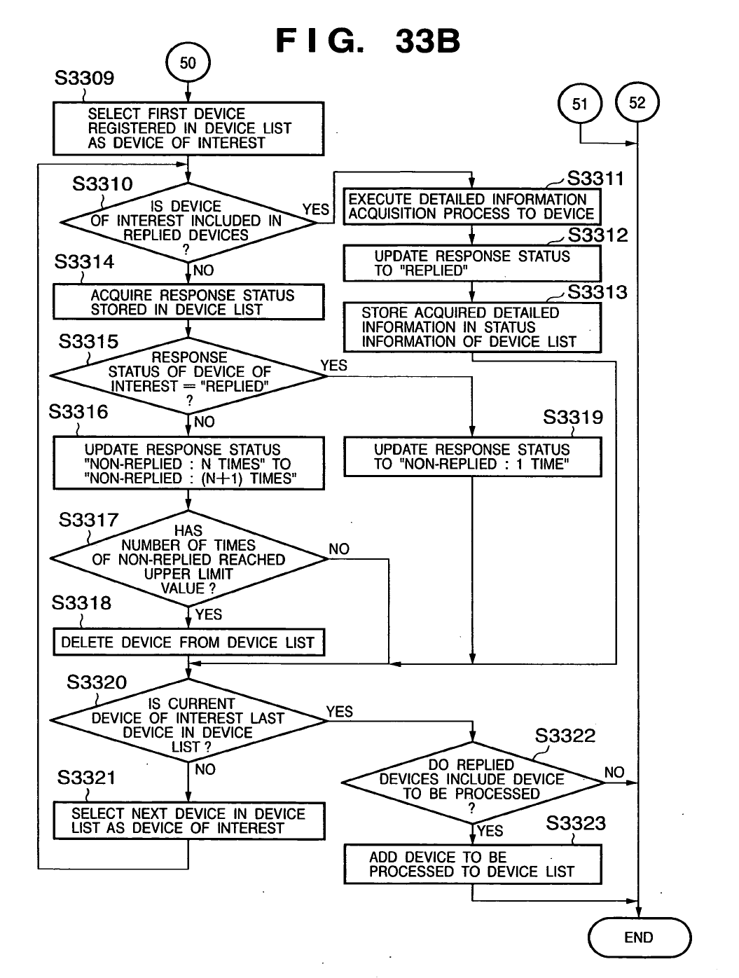

FIGS. 33A and 33B are flowcharts showing the basic operation of the information acquisition process 901 according to the 14th embodiment of the present invention.

It is determined in step S3302 whether the apparatus 100 is connected to the network 112. If the apparatus 100 is not connected to the network, the flow advances to step S3303 to select the first device registered in the device list stored in the data storage unit 2502 as a device of interest. The flow advances to step S3304 to record “unknown” in the response status field of the current device of interest in the device list. The flow advances to step S3305 to determine whether the current device of interest is the last device of the device list. If the device of interest is the last device, this process ends; otherwise, the flow advances to step S3306 to select a device next to the current device of interest registered in the device list as a new device of interest, and the flow returns to step S3304 to repeat the aforementioned process.

On the other hand, if it is determined in step S3302 that the apparatus 100 is connected to the network 112, the flow advances to step S3307 to execute a search process of devices to be managed, which are connected to the network 112. The flow advances to step S3308 to determine whether replied devices are detected. If replied devices are detected, the flow branches to step S3309 to select the first device registered in the device list as a device of interest. The flow advances to step S3310 to determine whether the device of interest is included in replied devices, which are found by the search process in step S3308. If the device of interest is included in the replied devices, the flow advances to step S3311 to acquire detailed information from the device. The flow advances to step S3312 to set “replied” as response status of the device stored in the device list. The flow advances to step S3313 to store the currently acquired detailed information in status information of the device stored in the device list. Upon completion of this process, the flow jumps to step S3320.

If it is determined in step S3310 that the device of interest is not included in the replied devices, the flow jumps to step S3314 to acquire response status of the device stored in the device list. The flow advances to step S3315 to determine whether the acquired status is “replied”. If the status is not “replied”, the flow advances to step S3316 to update the stored response status “non-replied: N times” (N is the number of times of non-replied, and is a natural number which does not exceed the upper limit value) to “non-replied: (N+1) times”. That is, the number of times of “non-replied” is counted. The flow advances to step S3317 to determine whether the number of times of non-replied (i.e., the (N+1) value), has reached the upper limit value of the number of times of non-replied. If the upper limit value has been reached, the flow advances to step S3318 to delete the current device of interest from the device list, and the flow advances to step S3320. If it is determined in step S3317 that the upper limit value has not been reached yet, the flow branches to step S3320.

If it is determined in step S3315 that the status is “replied”, the flow advances to step S3319 to delete the current response status “replied” and set “non-replied: 1 time”, and the flow advances to step S3320.

It is determined in step S3320 whether the current device of interest is the last device in the device list. If the device of interest is not the last device, the flow advances to step S3321 to select a device next to the current device of interest as a new device of interest, and then the flow returns to step S3310 to repeat the aforementioned process. If it is determined in step S3320 that the device of interest is the last device, the flow advances to step S3322 to determine whether the replied device include devices to be processed (i.e., devices which are not included in the device list). If such device is found, the flow advances to step S3323 to register such devices in the device list, thus ending the process. If it is determined in step S3322 that no device to be processed is found, the process ends.

If it is determined in step S3308 that no replied device is detected, the flow advances to step S3324 to select the first device registered in the device list as a device of interest. The flow advances to step S3325 to acquire response status of the device stored in the device list. The flow advances to step S3326 to determine whether the response status is “replied”. If the status is not “replied”, the flow advances to step S3327 to update the response status “non-replied: N times” (N is the number of times of non-replied to “non-replied: (N+1) times” (N is a natural number which does not exceed the upper limit value). That is, the number of times of “non-replied” is counted up. The flow advances to step S3328 to determine whether the number of times of non-replied (i.e., the (N+1) value), has reached the upper limit value of the number of times of non-replied. If the upper limit value has been reached, the flow advances to step S3329 to delete the current device of interest from the device list, and the flow branches to step S3331. If the upper limit value has not been reached yet, the flow branches to step S3331.

If it is determined in step S3326 that the status is “replied”, the flow advances to step S3330 to delete the current response status “replied” and set “non-replied: 1 time”, and the flow advances to step S3331. It is determined in step S3331 whether the current device of interest is the last device registered in the device list. If the device of interest is not the last device, the flow advances to step S3332 to select the next device registered in that device list as a new device of interest, and the flow returns to step S3325 to repeat the aforementioned process. If it is determined in step S3331 that the current device of interest is the last device registered in that device list, this process ends.

Note that this process is repeatedly launched as needed in response to a timer event and the like, and the contents of the device list stored in the data storage unit 2502 are updated every time this process is launched.

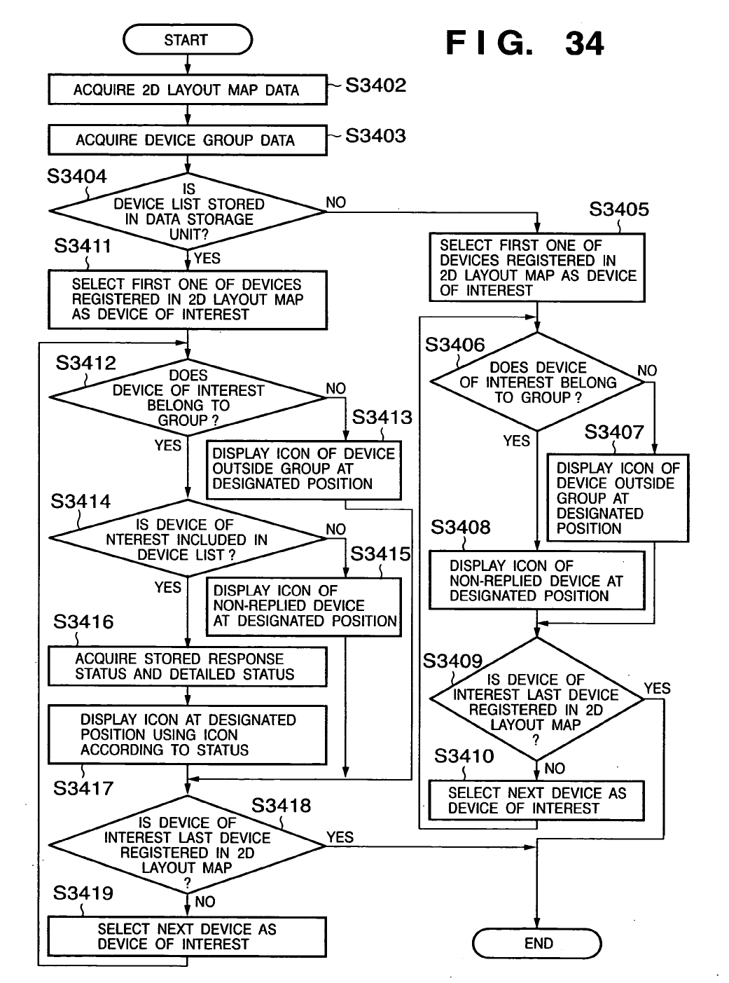

FIG. 34 is a flowchart showing the basic operation of the 2D layout map display process 2503 according to the 14th embodiment.

In step S3402, 2D layout map data to be displayed is acquired. The flow advances to step S3403 to acquire designated device group data. It is determined in step S3404 whether a device list is formed and stored in the data storage unit 2502. If no device list is stored in the data storage unit 2502, the flow advances to step S3405 to select the first one of devices registered in the 2D layout map data as a device of interest. The flow advances to step S3406 to determine whether the device of interest belongs to the designated device group. If the device of interest does not belong to the device group, the flow advances to step S3407 to display an icon used for a device outside the group at the designated position, and the flow advances to step S3409. On the other hand, if it is determined in step S3406 that the device of interest belongs to the group, the flow advances to step S3408 to display an icon used for a non-replied device at the designated position. The flow advances to step S3409 to determine whether the current device of interest is the last device registered in the 2D layout map data. If the device of interest is the last device, this process ends. On the other hand, if the device of interest is not the last device, the flow advances to step S3410 to select a device next to the current device of interest of those registered in the 2D layout map data as a new device of interest, and the flow returns to step S3406.

On the other hand, if it is determined in step S3404 above that the device list is stored in the data storage unit 2502, the flow advances to step S3411 to select the first one of devices registered in the 2D layout map data as a device of interest. The flow advances to step S3412 to determine whether the device of interest belongs to the designated device group. If the device of interest does not belong to the group, the flow advances to step S3413 to display an icon used for a device outside the group at the designated position for that device, and the flow jumps to step S3418.

If it is determined in step S3412 that the device of interest belongs to the group, the flow advances to step S3414 to determine whether the device of interest is included in the device list. If the device of interest is not included in the device list, the flow advances to step S3415 to display an icon used for a non-replied device at the designated position, and the flow jumps to step S3418.

If it is determined in step S3414 above that the device of interest is included in the device list, the flow advances to step S3416 to acquire response status and detailed status stored in that device list. The flow advances to step S3417 to display an icon corresponding to the status data acquired in step S3416 at the position corresponding to the device, and the flow advances to step S3418. It is determined in step S3418 whether the current device of interest is the last device registered in the 2D layout map data. If the device of interest is the last device, this process ends; otherwise, the flow advances to step S3419 to select a device next to the current device of interest of those registered in the 2D layout map data as a new device of interest, and the flow returns to step S3412 to repeat the aforementioned process.

As described above, according to the 14th embodiment, a device which does not belong to a group can be displayed using an icon that allows the user to identify such device, and the user can easily acquire the state of the designated group.

Since correspondence between actually laid-out devices and device icons on the window can be easily determined, devices can be easily managed on the 2D layout map display.

Furthermore, since the process for acquiring detailed information of a device and the process for displaying the 2D layout map are separated, the time or the like required to confirm whether a device replies can be suppressed from influencing on display of the 2D layout map, and the device status display efficiency can be greatly improved.

As described above, according to the 14th embodiment, the user can easily intuitively identify the actual locations of devices managed via the network. Even in a case where a device group is set, the device locations can be presented without introducing confusion about devices which are laid out actually. In this manner, more efficient, user-friendly device management can be implemented.

### Other Embodiments

The objects of the present invention are also achieved by supplying a storage medium, which records a program code of a software program that can implement the functions of the above-mentioned embodiments to a system or apparatus, and reading out and executing the program code stored in the storage medium by a computer (or a CPU or MPU) of the system or apparatus, as described above. In this case, the program code itself read out from the storage medium implements the functions of the above-mentioned embodiments, and the storage medium which stores the program code constitutes the present invention. As the storage medium for supplying the program code, for example, a floppy® disk, hard disk, optical disk, magneto-optical disk, CD-ROM, CD-R, magnetic tape, nonvolatile memory card, ROM, and the like may be used.

The functions of the above-mentioned embodiments may be implemented not only by executing the readout program code by the computer but also by some or all of actual processing operations executed by an OS (operating system) running on the computer on the basis of an instruction of the program code.

Furthermore, the functions of the above-mentioned embodiments may be implemented by some or all of actual processing operations executed by a CPU or the like arranged in a function extension board or a function extension unit, which is inserted in or connected to the computer, after the program code read out from the storage medium is written in a memory of the extension board or unit.

Note that the aforementioned embodiments may be practiced independently or in combination as needed.

The present invention is not limited to the above embodiment, and various changes and modifications can be made thereto within the spirit and scope of the present invention. Therefore, to apprise the public of the scope of the present invention, the following claims are made.

1. A device management method, comprising:
a display step of displaying information indicating a device on a map on the basis of map data including information indicating a name of the map, identification information of the device set in correspondence with the map, and information indicating a position of the device on the map; and
a registration step of registering the identification information of the device in the map data in accordance with correspondence between a location set for the device, and the information indicating the position of the device on the map.

2. The method according to claim 1, further comprising an instruction step of issuing an instruction for generating the map data,
wherein in said registration step, the identification information of the device is registered in the map data in accordance with the correspondence between the location set for the device and the information indicating the position of the device, in response the instruction issued in said instruction step.

3. The method according to claim 1, wherein in said registration step, the location set for the device is compared with the information indicating the position of the device on the map, and in a case where the location corresponds to the information indicating the position, the identification data of the device is registered in the map data.

4. The method according to claim 1, further comprising a search step of searching for a device connected to a network,
wherein in the registration step, the identification information of the device in the map information is registered in accordance with the correspondence between the location set for the device and the information indicating the position of the device on the map for each of one or a plurality of devices found in the search step.

5. The method according to claim 4, further comprising a checking step of checking if the identification information of each of the one or plurality of devices found in said search step is registered in the map data,
wherein in said registration step, the identification information of the device which is determined in said checking step that the identification information of the device is not registered, is registered in the map data in accordance with the correspondence between the location set for the device and the information indicating the position of the device on the map.

6. The method according to claim 5, further comprising:
a checking step of checking if the identification information of each of the one or plurality of devices found in said search step is registered in the map data; and
a delete step of deleting, in a case where a location set for a device which is determined in said checking step that the identification information of the device is registered, does not correspond to the information indicating the position of the device on the map, the identification information of the device from the map data.

7. The method according to claim 4, further comprising:
a storage step of storing information of the one or plurality of devices found in said search step; and
a confirmation step of confirming a response from each of the one or plurality of devices stored in said storage step,
wherein in said display step, a response status of the device is identifiably displayed on the map.

8. The method according to claim 7, wherein in said display step, an icon of a device is displayed on the map, and a display pattern of the icon is changed in accordance with the response status of the device.

9. The method according to claim 4, further comprising a determination step of determining whether or not each of the one or plurality of devices found in said search step belongs to a predetermined group,
wherein in the display step, the device is displayed on the map so as to determine whether or not the device belongs to the group.

10. A device management apparatus, comprising:
display means for displaying information indicating a device on a map on the basis of map data including information indicating a name of the map, identification information of the device set in correspondence with the map and information indicating a position of the device on the map; and
registration means for registering the identification information of the device in the map data in accordance with the correspondence between a location set for the device, and the information indicating a position of the device on the map.

11. The apparatus according to claim 10, further comprising instruction means for issuing an instruction for generating the map data,
wherein said registration means registers the identification information of the device in the map data in accordance with the correspondence between the location set for the device, and the information indicating a position of the device on the map, in response to the instruction issued by said instruction means.

12. The apparatus according to claim 10, wherein said registration means compares the location set for the device with the information indicating the position of the device on the map, and in a case where the location corresponds to the information indicating the position, said registration means registers the identification data of the device in the map data.

13. The apparatus according to claim 10, further comprising search means for searching for a device connected to a network,
wherein said registration means registers the identification information of the device in the map data in accordance with the correspondence between the location set for the device and the information indicating the position on the map, for each of one or a plurality of devices found by said search means.

14. The apparatus according to claim 13, further comprising checking means for determining whether the identification information of each of the one or plurality of devices found by said search means is registered in the map data,
wherein said registration means registers the identification information of the device in accordance with the correspondence between the location set for the device and the information indicating the position on the map, for the device which is determined by said checking means that the identification information of the device is not registered.

15. The apparatus according to claim 14, further comprising:
checking means for determining whether the identification information of each of the one or plurality of devices found by said search means is registered in the map data; and
delete means for, in a case where a location set for the device, which is determined by said checking means that the identification information of the device is registered, does not correspond to the information indicating the position on the map, deleting the identification information of the device from the map data.

16. The apparatus according to claim 13, further comprising:
storage means for storing information of the one or plurality of devices found by said search means; and
confirmation means for confirming a response from each of the one or plurality of devices stored by said storage means,
wherein said display means identifiably displays the response status of the device on the map.

17. The apparatus according to claim 16, wherein said display means displays the device on the map using an icon, and changes a display pattern of the icon in accordance with the response status of the device.

18. The apparatus according to claim 13, further comprising determination means for determining whether or not each of the one or plurality of devices found by said search means belongs to a predetermined group,
wherein said display means identifiably displays whether or not the device to be displayed on the map belongs to the group.

19. A storage medium storing a computer readable program, said program comprising:
a display step of displaying information indicating a device on a map on the basis of map data including information indicating a name of the map, identification information of the device set in correspondence with the map and information indicating a position of the device on the map; and
a registration step of registering the identification information of the device in the map data in accordance with the correspondence between a location set for the device, and the information indicating the position of the device on the map.

20. A program which is read and executed by a computer, comprising:
a display step of displaying information indicating a device on a map on the basis of map data including information indicating a name of the map, identification information of the device set in correspondence with the map and information indicating a position of the device on the map; and
a registration step of registering the identification information of the device in the map data in accordance with the correspondence between a location set for the device and information indicating the position of the device on the map.
